(19) United States
(12) Patent Application Publication
(10) Pub. No.: US 2015/0257381 A1
(43) Pub. Date: Sep. 17, 2015

(54) ANTIMICROBIAL POLYMERIC FILM AND COMPOSITION

(71) Applicant: Shenkar College of Engineering and Design, Ramat Gan (IL)

(72) Inventors: Amos OPHIR, Zikhron Ya'acov (IL); Roni EFRATI, Ramat-Gan (IL); Ana DOTAN, Ramat-Gan (IL); Shmuel KENIG, Haifa (IL)

(21) Appl. No.: 14/645,549

(22) Filed: Mar. 12, 2015

Related U.S. Application Data
(60) Provisional application No. 61/952,302, filed on Mar. 13, 2014.

(51) Int. Cl. A01N 31/08; A01N 25/34

(52) U.S. Cl. CPC A01N 31/08; A01N 25/34

(57) ABSTRACT

Disclosed is an antimicrobial sheet comprising a polymer, a nanoparticle, a foaming agent and an essential oil (EO). Further disclosed is a method for preparing such an antimicrobial sheet. In addition, the invention provides an antimicrobial polymeric coating comprising a polymer a surfactant and an EO.

### CROSS-REFERENCE TO RELATED APPLICATIONS

This application claims the benefit of U.S. Provisional Patent Application No. 61/952,302, filed Mar. 13, 2014, which is hereby incorporated by reference.

### FIELD OF THE INVENTION

This invention is directed to an antimicrobial polymeric film and to an antimicrobial polymeric composition. Particularly, the antimicrobial film and composition may serve to prolong the shelf life of food products without the use of preservatives.

### BACKGROUND OF THE INVENTION

Active packaging can be defined as a system in which the package, the product and the environment interact together for extending the shelf life of the product by changing the conditions inside the package, while maintaining the quality of the packaged product. Antimicrobial packaging is an active packaging that acts against proliferation of bacteria and fungus on the food surface. The activity of the active substance in the system can take place in three different ways: absorption, immobilization or release system, wherein the release system allows the migration or diffusion of the antimicrobial agent to the food surface through the headspace of the package or through the media that the food is found in. In order to improve the performance of the packaging it is essential to develop control of the active agent diffusion. If the concentration of the active agent is equal or above the minimum inhibitory concentration in the headspace of the package, the system will effectively decrease the proliferation of the bacterium and fungus.

In recent years, antibacterial food packaging, based on natural materials, have been developed. Among the natural antimicrobial agents that can be incorporated in the antimicrobial release system are essential oils (EOs) prepared from plant extracts. Essential oils (EOs) are known to have antimicrobial and antioxidant properties. Most EOs are approved for contact with food and are classified as generally recognized as safe” (GRAS) by the U.S. Food and Drug Administration (FDA). Various studies have examined the implementation of various EOs for the development of films with antibacterial properties, including thymol, carvacrol, eugenol, cinnamaldehyde and rosemary in different polymers.

Thymol, for example, is a component found in EOs of oregano and thyme; it has a phenolic structure and is known as very active against proliferation of different bacteria and fungi. The antibacterial properties of thymol and similar compounds are associated with their lipophilic character enabling the accumulation in cell membranes of microorganisms leading to the disruption of cell structure.

In certain instances, EOs may be readily integrated in various polymers, including polypropylene (PP), polyvinyl alcohol (PVOH), polycaprolactone, linear low density polyethylene (LLDPE), low density polyethylene (LDPE), ethylene vinyl acetate (EVA) and the like. The integration of the EOs into the polymers may be performed using a variety of methods, including solvent casting, extrusion film blowing, extrusion casting, compression molding, etc.

However, EOs are highly volatile compounds and therefore, the high processing temperature of polymeric films causes a high percentage of the EOs to evaporate. Thus, the incorporation thereof into polymeric films is hindered. Further, over time and use, especially when the storage environment is not optimal, it is possible that a certain percentage of the EOs incorporated in the polymeric sheet evaporate therefrom. In addition, blooming (the migration of additives to the polymer surface, such that those additives are accumulated on the surface, rather than being evenly distributed throughout the polymer) is a common phenomena when preparing polymer sheets with additives such as EOs. Therefore, there is a need in the art of a polymeric film in which EOs may be incorporated, without hindrance caused by the high processing temperature. There is further a need in the art for a polymeric film in which the EOs will remain incorporated over time, use and changing storage environment. In addition, there is a further need in the art for a polymer sheet in which the blooming phenomenon is reduced to a minimum.

Nano-clays (NCs) have been used in various polymers for improving polymeric mechanical and barrier properties. In addition, it was found that chemically treated NCs may provide higher adsorption capacity, depending on the chemical moieties used. Clay minerals have been modified with quaternary amine cations, replacing the exchangeable inorganic sodium, potassium, or calcium ions on the clay surface. The chemical treatment changes the hydrophilic nature of the NCs into hydrophobic. NCs are also known to increase the porosity of the polymeric film in which they are incorporated.

Another aspect of active packaging relates to antimicrobial compositions that are coated onto any appropriate type of packaging material. Existing solutions are based mainly on silver ions, quaternary ammonium cation, nisin, triclosan, and zeolite (generally prepared using the ion-exchange method). EOs may also be used in antimicrobial coatings. Incorporation of antimicrobial EO substances within the bulk or coating of the packaging may be more efficient if inhibitory concentrations are maintained by slow release of the active agents to the headspace of the food package.

Han et al. (2000) disclosed that a polymer-based solution coating would be the most desirable method in terms of stability and adhesiveness of attaching a bacteriocin to a plastic film. LDPE film was successfully coated with nisin using methylcellulose (MC)/hydroxypropyl methylcellulose (HPMC) as a carrier. The production of a multilayered antimicrobial film by solution coating of Grapefruit seeds extract (GFSE) coated films in polyamide (Versamid 750) also presented antimicrobial effects in ground beef packaging. However, commercial active compositions are not known in the art. Further, EOs are known to modify the flavor of the food and therefore, the control of the amount of EO released from the antibacterial coating is essential for the preparation of commercial antimicrobial packaging, based on coating antimicrobial materials on prepared packages.

### SUMMARY OF THE INVENTION

This application is directed to an antimicrobial sheet comprising a polymer, a nano-clay, a foaming agent and an essential oil (EO). The application is further directed to a method for preparing the antimicrobial sheet comprising: preparing a concentrate comprising a first polymer, a foaming agent and a nano-clay; adding an antimicrobial material to the concentrate to provide an antimicrobial concentrate; and preparing a polymeric sheet from the antimicrobial concentrate, with the addition of a second polymer. The application is further directed to an antimicrobial polymeric coating comprising a polymer, a surfactant and an EO. The application is further directed to a non-woven fabric impregnated with the antimicrobial polymeric coating.

Embodiments of the invention are directed to an antimicrobial sheet comprising a polymer, a nanoparticle, a foaming agent and an essential oil (EO). According to some embodiments, the antimicrobial sheet further comprises a compatibilizer, an additional nano-particle, an emulsifier, an additional functional additive or any combination thereof. According to some embodiments, the the nano-particle is a nanoclay. According to further embodiments, the nano-particles are exfoliated.

According to some embodiments, the antimicrobial sheet comprises one layer. According to other embodiments, the antimicrobial sheet comprises two or more layers, wherein the nano-particles and the EO molecules are in the same layer or in different layers. According to some embodiments, the antimicrobial sheet provides a controlled release of the EO from the sheet.

Some embodiments are directed to an antimicrobial sheet, as detailed herein, for use in packaging a product that requires the control of the development of microbes therein or thereon.

Some embodiments are directed to a method for preparing the antimicrobial sheet as detailed herein, comprising

preparing a concentrate comprising a first polymer, a foaming agent and a nano-particle;

adding an antimicrobial material to the concentrate to provide an antimicrobial concentrate; and preparing a polymeric sheet from the antimicrobial concentrate, with the addition of a second polymer.

According to some embodiments, the first polymer and the second polymer are the same type of polymer. According to further embodiments, the concentrate further comprises a compatibilizer, an additional nano-particle, an emulsifying agent, an additional functional component, or any combination thereof. According to some embodiments, the concentrate is prepared as a porous granule nano-composite. According to some embodiments, the nano-particles are nano-clays.

Some embodiments of the invention are directed to an antimicrobial polymeric coating comprising a polymer, a surfactant and an EO. According to some embodiments, the antimicrobial polymeric coating further comprises a solvent. According to other embodiments, the coating is solvent-free.

Some embodiments are directed to the use of more than one coating for providing a multilayer coating, wherein at least one coating is the antimicrobial polymeric composition, as detailed herein. Some embodiments are directed to a non-woven fabric impregnated with the antimicrobial polymeric coating, as detailed herein. According to some embodiments, the non-woven fabric is coated on at least one side with an additional polymeric coating. According to some embodiments, the non-woven fabric is further laminated, on at least one side, with a thin polymeric film.

According to some embodiments, the polymer in the antimicrobial polymeric coating is an adhesive resin. According to some embodiments, the adhesive resin is sandwiched between two polymeric films. According to some embodiments, the polymer in the antimicrobial polymeric coating is a multi-phase polymer media blend. According to some embodiments, the antimicrobial polymeric coating further comprises a nano-particle, which may be a nano-clay.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other characteristics and advantages of the invention will be better understood through the following illustrative and non-limitative detailed description of preferred embodiments thereof, with reference to the appended drawings, wherein:

FIGS. 1A, 1B, 1C, 1D, 1E and 1F present the blooming of polymers comprising different concentrations of nano-clays;

FIG. 2 presents the fraction of the EO remaining in various polymeric films, differing from one another in their polymeric densities;

FIG. 3 presents the fraction of the EO remaining in various polymeric multilayered films, differing from one another in the contents of the outer layers of the films;

FIG. 4 presents the influence of the external layer density on EO migration;

FIG. 5 presents the influence of the external layer polarity on EO migration;

FIG. 6 presents the EO concentration .vs. time for polymers having different levels of density/crystallinity;

FIG. 7 presents the EO concentration .vs. time for multilayered polymeric films, wherein the external layers differ from one another in their polymeric densities;

FIG. 8 presents the EO concentration .vs. time for multilayered polymeric films, wherein the external layers differ from one another in their polymeric polarities;

FIG. 9 presents the attenuated total reflectance (ATR) spectrum of thymol;

FIG. 10 presents the FTIR spectra of LDPE with and without the addition of thymol;

FIG. 11 presents the FTIR spectra of EVA-9 with and without the addition of thymol;

FIG. 12 presents the FTIR spectra of EVA-19 with and without the addition of thymol;

FIG. 13 presents the FTIR spectra of EMA with and without the addition of thymol;

FIG. 14 presents the FTIR spectra of different polymers (EMA, EVA-9, EVA-19 and LDPE) with thymol;

FIGS. 15A, 15B and 15C are 3D plots of data for polyethylene (15A), polyvinyl acetate (PVA) (15B) and poly butyl acrylate (PBA) (15C), represented by the sphere and light gray dot, wherein the dark gray dots represent the thymol;

FIG. 16 is a 2D plot of data for polyethylene, polyvinyl acetate (PVA) and polymethyl methacrylate (PMMA), represented by the spheres having a black dot at their center, wherein the light gray dots, being either solid light grey dots or small spheres/unfilled dots, represent the thymol;

FIG. 17 presents a DSC graph of neat MDPE compared with composite film with and without EO;

FIG. 18 presents a DSC graph of neat LDPE compared with composite film with and without EO;

FIG. 19 presents a DSC graph of neat VLDPE compared with composite film with and without EO;

FIG. 20 presents the melting temperature of polymers and nanocomposites, with and without EO;

FIG. 21 presents the antibacterial activity of Thymol-containing films;

FIG. 22 presents the thermal stability of thymol mixed with various nano clays;

FIG. 23 presents the influence of a foaming agent, EO and the combination of both on the G′ value for 10 wt % NC versus frequency;

FIG. 24 presents the G′ value for different NCs concentration, at a frequency of 0.1987 rad/sec;

FIG. 25 presents SEM images of polymeric films comprising 1% wt NCs or 10% wt NCs with and without an EO and/or a foaming agent;

FIG. 26 presents the XRD results of a foamed master batch with (dark gray) and without (light gray) the addition of an EO (thymol) in a master batch comprising 9% wt NC;

FIG. 27 presents the XRD results for films comprising 3% wt NC prepared with (dark gray) and without (light gray) a foaming agent;

FIG. 28 presents the XRD results for films comprising 7% wt NC with (dark gray) and without (light gray) a foaming agent;

FIG. 29 presents the EO % wt concentration in the film after extrusion casting .vs. NC concentration in films prepared with and without a foaming agent;

FIG. 30 presents the EO content in the film vs. time in exposed films at room temperature;

FIG. 31 presents the release of the EO into the vial headspace .vs. time; and

FIG. 32 presents the antibacterial activity of thymol-containing films.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terms “sheet” and “film” as used herein are to be understood as having their customary meanings as used in the thermoplastic and packaging arts. Those terms, as well as other equivalent terms, are interchangeable throughout.

The term “about” as used herein is to be understood to refer to a 10% deviation in the value related to.

Some embodiments of the invention are directed to an antimicrobial sheet comprising a polymer, a nanoparticle, an antimicrobial material, such as an EO, and a foaming agent. As detailed herein, the addition of a foaming agent may aid in creating a micro-porous structure that allows the absorption of the antimicrobial material into the antimicrobial sheet. Accordingly, in the films detailed herein, the layer comprising the antimicrobial material, e.g., the EO, further comprises a foaming agent. According to some embodiments, the nanoparticle is a nanoclay. According to some embodiments, the nano-particle is not a nano clay. According to some embodiments, any of the nano particles related to herein may be treated, e.g., exfoliated, in order to achieve desired properties. It is further noted that, unless specifically noted otherwise, or unless it would be clear to a person skilled in the art that it would not be feasible, whenever nanoclays are mentioned, the term may be broadened to include other types of nanoparticles as well.

According to some embodiments, the polymer is a polyolefin (PO) polymer, a co-polystyrene, a polyamide, a co-polyamide or any immiscible blend thereof. It is noted that herein and throughout, unless specifically mentioned otherwise, the reference to “the polymer” may relate to the first polymer, the second polymer or both.

According to some embodiments, the antimicrobial sheet further comprises a compatibilizer, an additional nano-particle, an emulsifier, an additional functional component, or any combination thereof.

According to some embodiments, the additional nano-particle is a nano-clay. According to some embodiments, the additional nano-particle is not a nano clay. According to some embodiments, any of the nano particles related to herein may be treated, e.g., exfoliated, in order to achieve desired properties.

According to some embodiments, the antimicrobial sheet is used in packaging any product that requires the control of the development of microbes therein/thereon, such as food and drink products, as well as cosmetics. Such antimicrobial sheets may be used in order to prolong the shelf life of any desired product.

According to some embodiments, the antimicrobial polymeric sheet is prepared from a concentrate of a highly porous granule nanocomposite comprising a first polymer, a foaming agent and a nano-particle. According to some embodiments, the concentrate may further include a compatibilizer, an additional nano-particle, an emulsifier, an additional functional component, or any combination thereof. According to some embodiments, the concentrate is prepared using a twin screw extruder, thus providing a highly porous granule nano-composite.

Once the highly porous granule nano-composite is prepared, at least one antimicrobial material, e.g., an EO, is incorporated therein. According to some embodiments, the antimicrobial material is incorporated into the pores of the granules as well as the polymer free space by dry mixing. According to some embodiments, the dry mixing is performed in a high speed mixer. According to some embodiments, the dry mixing is performed at a temperature of about 50° C. According to further embodiments, the dry mixing is performed at a temperature of between about 50-70° C. According to further embodiments, the dry mixing is performed at a temperature of between about 40-50° C. According to further embodiments, the dry mixing is performed at a temperature of between about 50-60° C. According to further embodiments, the dry mixing is performed at a temperature of between about 60-70° C. According to further embodiments, the dry mixing is performed at a temperature of between about 70-80° C. According to some embodiments, the dry mixing temperature is selected so that it is at least the melting point of the EO, so that the EO is in liquid state. According to some embodiments, the dry mixing temperature is further set according to the polymer utilized in the concentrate. If the EO is thymol, the dry mixing temperature may be between about 50-70° C.

After the antimicrobial material is incorporated into the highly porous nano-composite, the polymeric sheet is prepared therefrom, with the addition of an appropriate amount of a second polymer, by any appropriate means, including single screw cast extrusion or blow extrusion. According to some embodiments, the additional amount of polymer, i.e., the second polymer, is the same type of polymer used to prepare the highly porous nano-composite, i.e., the first polymer. According to other embodiments, the additional amount of the polymer, i.e., second polymer, is not the same type of the polymer used to prepare the highly porous nano-composite, i.e., the first polymer. According to some embodiments, the antimicrobial sheet is prepared implementing only one intensive thermal process, thereby minimizing the percentage of EOs evaporating.

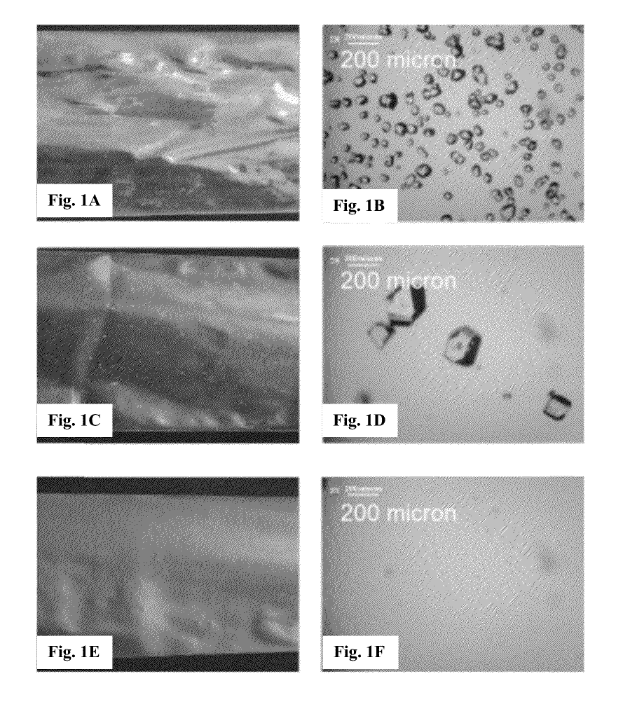

The use of nanoparticles, such as nanoclays, in the concentrate allows the formation of highly porous granules, which, as detailed herein, enables the incorporation of the antimicrobial material, e.g., the EO, into the porous granules, such that a relatively high amount of the antimicrobial material may be incorporated into the granules. Further, the EO is not readily released form the granules, even when preparing the polymeric sheet under relatively high temperatures. Further, when the prepared antimicrobial polymeric sheet is used for packaging any type of product, the incorporation of the antimicrobial material into the porous granules controls the release rate of the antimicrobial material from the polymeric sheet packaging into the packaged product and/or its surroundings. In addition, as presented in FIGS. 1A and 1B (1% wt NC), 1C and 1D (5% wt NC), and lE and 1F (10% wt NC), the use of nano-particles inhibits the blooming phenomenon, i.e., the migration of additives, such as antimicrobial materials, to the surface of the polymeric sheet.

According to some embodiments, the PO polymer may be a low density polyethylene (LDPE), linear low density polyethylene (LLDPE), metallocene linear low density polyethylene (mLLDPE), linear medium density polyethylene (LMDPE), high density polyethylene (HDPE) ethylene vinyl alcohol (EVA), ethylene methyl acrylate (EMA), ethylene ethyl acrylate (EEA), ethylene butyl acrylate (EBA) or a polypropylene (PP) copolymer.

According to further embodiments, the polymer may be a polyamide, such as PA6, PA66, PA6/66 or PA6/12. According to further embodiments, the polymer may be a styrene co-polymer, such as styrene ethylene butylene styrene (SEBS), styrene butadiene (SB) and styrene butadiene styrene (SBS)

According to further embodiments, the polymer in the concentrate is substituted with an immiscible blend of a PO polymer and a polymide or a PO polymer and a styrene, such as PO/co-polyamide (PO/coPA). According to some embodiments, the polymer is a co-polyamide nylon 6/66, nylon 6/12, or any combination thereof. According to some embodiments, the formation of a two-phase concentrate enables the antimicrobial material to be highly incorporated into one phase, while, during heat treatment and/or use, the antimicrobial material may diffuse into the other phase, thus allowing the antimicrobial material to remain in the prepared polymeric sheet throughout the different preparation and usage stages.

According to some embodiments, the polymer density and its degree of crystallinity is controlled, so as to affect the diffusion kinetics of the antimicrobial material through the polymer matrix. The polymer density and crystallinity of the final antimicrobial sheet is determined according to the types of polymers utilized in the preparation of the antimicrobial sheet, and further influenced by the manufacturing conditions. In general, increasing the degree of crystallinity causes the diffusion of the antimicrobial material through the polymer matrix to be slower. On the other hand, since crystals are impermeable, they do not absorb the antimicrobial material, thus, in the impregnation stage, a higher degree of crystallinity can lead to a decrease in absorption rate. Therefore, the degree of crystallinity is controlled such that it is low enough for the antimicrobial material to be absorbed in the polymeric matrix, though high enough so that the antimicrobial material does not immediately diffuse out of the polymeric matrix.

According to some embodiments, the type of polymer matrix, e.g., the polarity thereof, is set according to the affinity thereof with the particular antimicrobial material to be absorbed therein. The higher the affinity between the antimicrobial material and the polymeric matrix, the higher the absorption of the antimicrobial material into the matrix; however, the diffusion rate of the antimicrobial material from the matrix in lowered. Therefore, the interaction between the antimicrobial material and the polymeric matrix may be used to control the initial absorption of the antimicrobial material into the matrix, as well as the release profile of the antimicrobial material therefrom.

According to some embodiments, the nano-clay is selected from montmorillonite or other types of bentonites. According to some embodiments, the nano-particles are chemically treated, e.g., with quaternary amine cations, to replace inorganic ions, such as sodium, potassium and calcium, on the clay surface. Such chemical treatment of the nano-particles may change the nano-particles nature from hydrophilic to hydrophobic, increasing the distribution of the nano-particles particles throughout the polymer. According to some embodiments, the nano-particles are exfoliated using a quaternary ammonium organic modifier.

According to some embodiments, the compatibilizer is added to the polymer by grafting, such as a PO polymer grafted maleic anhydride (g-MAH), ethylene grafted methacrylic acid, sodium ionomer of ethylene grafted methacrylic acid or any other appropriate polymer grafted with a compatibilizer. The grafting with a compatibilizer may aid in dispersion of the nanoclays throughout the polymeric matrix. According to some embodiments, the additional nano-particle is a silicate.

According to some embodiments, the foaming agent is in the form of a concentrate. According to some embodiments, the amount of the foaming agent concentrate is more than about 0.5% w/w. According to some embodiments, the amount of the foaming agent concentrate is about 0.2-2.0% w/w. According to some embodiments, the amount of the foaming agent concentrate is about 0.2-0.5% w/w. According to some embodiments, the amount of the foaming agent concentrate is about 0.5-1.0% w/w. According to some embodiments, the amount of the foaming agent concentrate is about 1.0-1.5% w/w. According to some embodiments, the amount of the foaming agent concentrate is about 1.5-2.0% w/w. The foaming agent may be endothermic, based on citric acid or agents comprising the same. The foaming agent may be exothermic, based on diazocarbonamide or agents comprising the same. As used herein the terms foaming agent, foaming agent concentrate, foaming concentrate and the like are interchangeable. According to some embodiments, the foaming agent is added in order to increase the ability of the prepared concentrate to absorb the antimicrobial material by creating micro-cavities in the nano-composite concentrate. According to further embodiments, the foaming agent reduces the loss of EOs during processing under heat. The use of the foaming agent may also exfoliate the nano-particles particles, which could also contribute to a higher ability of absorbing an antimicrobial material into the granules. According to some embodiments, the combined implementation of a foaming agent and an EO allows nano-particles, such as nano-clays, to be uniformly dispersed throughout the prepared antimicrobial film. According to further embodiments, the foaming agent delays the release of the EO from the antimicrobial film. According to some embodiments, the foaming agent is endothermic. According to other embodiments, the foaming agent is exothermic. Generally, an endothermic foaming agent produces closed cavities, while an exothermic foaming agent produces opened cavities. Opened cavities could more readily absorb the antimicrobial material into the granules; however, closed cavities may improve the stability of the antimicrobial material being incorporated in the granules, even when undergoing extrusion under heat. Closed cavities may also be advantageous in obtaining a slow release profile of the antimicrobial material from the polymeric sheet over time and use. Accordingly, it is possible to use at least two foaming agents, one endothermic and one exothermic.

According to some embodiments, the polymer sheet includes a single polymeric layer. According to further embodiments, the polymeric sheet includes at least two layers, wherein each layer may be designed to have different properties, all of which, together, bring to an optimum (1) the absorption of the antimicrobial material into the concentrate from which the sheet is prepared; (2) the remaining of the antimicrobial material in the prepared sheet, even after heat treatment; and (3) the release profile of the antimicrobial material over time and use of the sheet.

According to some embodiments, when a multilayered sheet is prepared, only one layer includes an antimicrobial material. According to other embodiments, more than one layer includes an antimicrobial material. According to some embodiments, any two layers may comprise different antimicrobial materials. According to some embodiments, two or more different antimicrobial materials may be used in the same layer.

According to some embodiments, a layer containing an antimicrobial material may be prepared between two polymeric layers that do not include an antimicrobial material, such that diffusion rate of the antimicrobial material may be controlled depending on the density, porosity, crystallinity and/or polarity of the polymers in any one of the layers adjacent to the layer comprising the antimicrobial material.

According to some embodiments, in single layer films less EO is evaporated during processing when in the polymer's density is increased, and therefore, single layered films may be prepared from relatively dense polymers. According to some embodiments, the preparation of multilayer sheets decreases the affect of crystallinity (density) of the polymers on the EO desorption/absorption.

According to some embodiments, the polymer in the single layered sheet is a polar polymer. The polarity of the polymer may affect the interaction thereof with the EO, such that polar polymers having a stronger interaction with the EO may decrease the desorption rate thereof. According to some embodiments, the layer in the multilayered sheet comprising the EO is prepared from a polar polymer. According to some embodiments, the outer layers in a multilayered sheet (that do not include an EO) comprise polar polymers, which may also inhibit the desorption of the EO from the sheet. According to further embodiments, the outer layers in a multilayered sheet (that do not include an EO) comprise non-polar polymers, thereby increasing the antimicrobial properties of the sheet.

The preparation of single or multi layered sheets may be achieved, using co-extrusion or a combination of hot lamination and extrusion coating.

According to some embodiments, the polymeric sheet includes the following three layers:
Layer 1: mLLDE;
Layer 2: LPE nanocomposite+EO+foaming agent; and
Layer 3: low, medium or high density linear polyethylene.

According to some embodiments, the polymeric sheet includes the following three layers:
Layer 1: polyethylene polar−copolymer (ethylene vinyl acetate (EVA), ethylene methyl acrylate (EMA), ethylene ethyl acrylate (EEA), ethylene methacrylic acid (EMAA));
Layer 2: LPE nanocomposite+EO+foaming agent; and
Layer 3: low, medium or high density linear polyethylene.

According to some embodiments, the polymeric sheet includes the following three layers:
Layer 1: mLLDE;
Layer 2: PO/coPA nanocomposite+EO+foaming agent; and
Layer 3: low, medium or high density linear polyethylene.

According to some embodiments, the polymeric sheet includes the following three layers:
Layer 1: polyethylene polar−copolymer (EVA, EMA, EEA, EMAA);
Layer 2: PO/coPA nanocomposite+EO+foaming agent; and
Layer 3: low, medium or high density linear polyethylene.

It is noted that although the examples above relate to three layered sheets having the EO in the middle layer, the multilayered sheet may comprise any number of layers and further, the EO may be in any of those layers, being either internal (between two adjacent layers) or external (adhered to only one additional layer), wherein the number of layers, their contents and the placement of the EO layer in the sheet may all influence the release rate and release direction of the EO from the sheet.

According to some embodiments, the polymeric sheet is a single layer sheet comprising a linear polyethylene nanocomposite+EO+foaming agent. According to some embodiments, the polymeric sheet is a single layer sheet comprising a PO/coPA nanocomposite+EO+foaming agent.

Further embodiments of the invention are directed to antimicrobial polymeric compositions for coating on packaging. When used in a coating, heat application may not be necessary, which may prove advantageous in preventing the loss of the active antimicrobial ingredient when heat treatment is applied. The packaging may be any appropriate type of packaging, including flexible polymeric packaging, rigid polymeric packaging, cardboard, fabric, non-woven fabrics, bottles, glass and the like. The polymer in the antimicrobial polymeric composition may be selected from urethane acrylate, bi-component polyurethane coating media, polyamide coating media, or any appropriate combination thereof. The type of polymer/polymeric mixture used may have any appropriate density and/or polarity, in order to regulate the absorption and desorption of the EO. It is noted that although related to herein as a “coating” the antimicrobial formulation may be either coated onto or impregnated into any appropriate packing materials.

According to some embodiments, the antimicrobial composition/sheet comprises an EO. It is noted that, unless specifically mentioned otherwise or unless would be otherwise obvious to a person skilled in the art, the “antimicrobial composition” includes both an antimicrobial sheet and an antimicrobial coating.

According to some embodiments, the EO is carvacol, citral, eugenol, thymol, cinnamaldehyde, vanillin, salicylaldehyde, menthol, linalool, estragol, cineol/cineole, eucalyptol, allylisothiocyanate, β-caryophyllene, curcumin or any combination thereof, wherein the specific EO or combination of EOs may be chosen according to the product to be preserved, the length of time and preservation conditions, the type of packaging, and the like. According to some embodiments, the concentration of the EO in the composition is between about 10% w/w and 20% w/w. According to some embodiments, the concentration of the EO in the composition is between about 10% w/w and 13% w/w. According to some embodiments, the concentration of the EO in the composition is between about 13% w/w and 16% w/w. According to some embodiments, the concentration of the EO in the composition is between about 16% w/w and 20% w/w. According to some embodiments, the concentration is between 7-20% W/W. The w/w% in the coating relates to the coating after drying.

According to some embodiments, the composition comprises nano-particles, such as nano-clays. According to some embodiments, the nano-particles control the release rate of the antimicrobial material. According to some embodiments, the nano-particles are selected from ultra-porous active nano-beads, montmorillonite layer silicate, vermiculite and kaolinite nano-platelets. According to some embodiments, the concentration of the nano-particles in the composition is between about 3-10% w/w. According to some embodiments, the concentration of the nano-particles in the composition is between about 3-5% w/w. According to some embodiments, the concentration of the nano-particles in the composition is between about 5-7% w/w. According to some embodiments, the concentration of the nano-particles in the composition is between about 7-10% w/w.

According to some embodiments, the polymeric medium in the polymeric antibacterial composition comprises urethane-acrylate, ethylene-vinyl-acetate, a polyamide and the like or any appropriate combination thereof.

The polymeric coating composition may include any type of solvent, such as water. According to some embodiments, the solvent is evaporated from the system after the composition is coated on a substrate, such as a packing material. According to other embodiments, the composition is solvent free. According to some embodiments, the composition comprises adhesives, such as polyurethane adhesives. According to further embodiments, the polymeric antimicrobial coating comprises an immiscible blend of urethane-acrylate/ethylene-vinyl-acetate or polyamide/ethylene-vinyl-acetate and the like.

According to some embodiments, the antimicrobial coating comprises a surfactant. According to some embodiments, the surfactant is TWIN-20.

According to some embodiments, more than one composition is provided, wherein each composition is unique and the use of several compositions together, e.g., in coating several different layers on the packaging material. The interaction between the different layers of coatings may provide enhanced antimicrobial properties to the packaging material. According to some embodiments, a second layer is coated on the antimicrobial coating in order to control the release rate of the antimicrobial material. According to some embodiments the second layer includes nano-particles. According to one embodiment, the active material is included in only one of the layers. According to further embodiments, the active material is included in at least two layers. According to some embodiments, any two layers may include any two different active materials. According to some embodiments, one layer may include more than one active material. According to some embodiments, at least one layer comprising an active material is an internal layer, i.e., is coated below at least one additional layer.

According to some embodiments, the coating thickness, or the coating layer thickness is in the range of about 5-50 micron. According to some embodiments, the coating thickness, or the coating layer thickness is in the range of about 5-10 micron. According to some embodiments, the coating thickness, or the coating layer thickness is in the range of about 10-20 micron. According to some embodiments, the coating thickness, or the coating layer thickness is in the range of about 20-30 micron. According to some embodiments, the coating thickness, or the coating layer thickness is in the range of about 30-40 micron. According to some embodiments, the coating thickness, or the coating layer thickness is in the range of about 40-50 micron.

According to some embodiments, the composition further includes an emulsifying agent. Such an emulsifying agent allows the EOs, which are oils, to be emulsified in water based solutions. According to some embodiments, polysorbate micro-encapsulment is used. According to some embodiments the composition comprises one phase. According to other embodiments, the composition comprises more than one phase.

According to some embodiments, at least one composition is impregnated into a non-woven fabric or any other appropriate type of material. The composition impregnated into the non-woven fabric may include at least one EO with or without a nano-particle. The impregnated non-woven fabric may then be coated, on one or both sides, with additional polymeric compositions, possibly comprising nano-particles for regulating the EO release and/or additional EOs for providing additional protection to the packaged product.

According to some embodiments, a thin polymeric film may be laminated, by cold or hot lamination, onto one or both sides of the impregnated non-woven fabric. According to some embodiments, the thin polymeric film is prepared from a polyolefin or pressure sensitive adhesive film (PSA).

According to some embodiments, the EO is incorporated into an adhesive layer in film laminates. Particularly, the EO may be incorporated into an adhesive resin, e.g., a solventless bi-component polyurethane (PU) adhesive resin, which is sandwiched between two polymeric films, e.g., polyethylene terephthalate, a polyolefin, polypropylene film, by cold lamination. According to some embodiments, the polymer adhesive resin containing the EO performs as a reservoir layer between a thin top layer, e.g., a polyolefin, able to regulate the release of the EO, and a bottom layer, e.g., polyethylene terephthalate, acting as a barrier layer, through which the EO does not diffuse, or diffuses in minuscule amounts. According to some embodiments, any one of the external layers may include nano-particles or any other appropriate materials in order to regulate the release of the EO from the resin layer.

According to some embodiments, nanoparticles, such as nanoclays, are included in the antimicrobial coating when the coating is placed under any type of covering film/outer layer, or between two external layers.

According to some embodiments, the EO may be incorporated in a single phase polymeric medium. According to further embodiments, the EO may be incorporated into a multi-phase immiscible polymer media blend. When using such a blend, the EO diffuses into its thermodynamically favorable phase. According to further embodiments, when nano-particles are also included in the multi-phase media, they too diffuse into their thermodynamically favorable phase. Such a multi-phase media may improve the absorption and tenure capability of the EO in the bulk of the polymeric medium. Further, the multi-phase media and the dispersion of the EO and nano-particles throughout may control the diffusion rate of the EO from the polymeric coating. Such control may lead to long-lasting microbial protection capabilities, prolonging the shelf life of the packaged product.

According to some embodiments, an antimicrobial polymeric sheet and/or an antimicrobial coated material may be placed inside a package, either in directed contact with the contents or not, and by release of the antimicrobial material from the antimicrobial polymeric sheet and/or an antimicrobial coated material, preservative properties are provided to the contents of the package (by directed contact and/or through the headspace).

Various aspects of the invention are described in greater detail in the following Examples, which represent embodiments of this invention, and are by no means to be interpreted as limiting the scope of this invention.

### EXAMPLES

### Example 1

### Influence of the Crystallinity, Density, and Polarity of the Polymeric Matrix, as well as the Affinity thereof with an Essential Oil (EO) on the Desorption and Absorption of the EO

### Materials

The following study implemented the following three polymers in order to assess the affect of the degree of crystallinity and the density of the polymeric matrix on the EO absorption and desorption: linear low density polyethylene (LLDPE) LL-118 grade of BRASKEM, having melt flow index (MFI) of 1.0 g·10 min⁻¹, and density of 0.916 g·cm⁻³; medium density polyethylene (MDPE), MarFlexVR HHM TR 130, having an MFI of 0.3 g·10 min⁻¹ and a density of 0.937 g·cm⁻³; and metallocene linear low density polyethylene (mLLDPE)—Affinity 1880G, having an MFI of 1.0 g·10 min ⁻¹, and a density of 0.902 g·cm⁻³.

The study further implemented the following three polymers in order to access the influence of the polymer matrix polarity as well as the chemical affinity between the different components in multilayered film systems on the EO absorption and desorption kinetics: Escorene Ultra FL 00209-Ethylene vinyl acetate copolymer resin (MFI of 2.1 g·10 min⁻¹, density of 0.931 g cm⁻³ and vinyl acetate content of 9.4% w/w); Cynpol EVA 0218-Ethylene vinyl acetate copolymer resin (MFI of 2.0 g·10 min⁻¹, density of 0.938 g cm⁻³, and vinyl acetate content of 18% w/w); and DuPontTM ElvaloyVR AC 1820 with 20 wt % Methyl Acrylate comonomer content (MFI of 8.0 g·10 min⁻¹, and density of 0.942 g cm⁻³).

The antimicrobial material was chosen to be the EO thymol (99.5%), purchased from Sigma-Aldrich (Israel). Also PE-g-MAH Bondyram-4108 purchased from Polyram, Israel and TRACEL PO 2201 of Tramaco have been used, respectively, as compatibilizing and foaming agents. The organically modified clay Cloisite 15A, based on dimethyl, dehydrogenated tallow, (DMDT-MMT), formulated as follows:

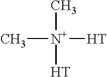

(HT=hydrogenated tallow (˜65% C18, ˜30% C16 and ˜5% C14)) was supplied by Southern Clay AQ1 Products/Rockwood Additives (dried in vacuum oven at 110° C. overnight before use in melt processing; Table I).

### Sample Preparation

Several formulations were obtained using a three stage process, aiming at minimizing the loss of active substance (thymol) during thermal processing:
(i) a polymer concentrate (referred to herein also as a master batch) was produced by melt blending the materials in a twin screw extruder at 230° C., 250 rpm, producing a nanocomposite granulate (referred to herein also as pellets or foamed pellets). Different concentrations of nano-clays (NCs) and foaming agents (TRACEL PO 2201) were implemented together with polymer(s) and compatibilizer(s) (Bondyram-4108).
(ii) The absorption of EO by the foamed pellets was performed by mixing the pellets with the EO in a closed tank at 70° C. for 24 h.
(iii) Antimicrobial films were produced by dry mixing the EO containing master batches with an additional amount of polymer in a cast extrusion machine at 230° C.
   Three single layer films, based on three different polymer densities, as well as six different multilayer films were produced. Samples without the addition of an active ingredient (EO) were also prepared for control. The average thickness of the films was ˜100 μm.

### Material Characterization

The active films were characterized using different techniques to investigate their ability to absorb and control the release of the EO from the film. The thermal and antimicrobial properties of the films were studied as well.

### Quantitative Analysis of EO Concentration in the Film

The amount of thymol in the samples was determined by UV-visible spectroscopy. The films were cut into small pieces and immersed in 2-propanol (1 mL 2-propanol for every 20 mg of film). Thymol was extracted by refluxing for 60 min. To 100 mL volumetric flasks containing 10 mL of a Standard Buffer Solution (Boric Acid1Potassium Chloride, 0.2M), 1 mL of Chlorimide solution (Gibbs reagent), 4 mL of 2-propanol, and 1 mL of the extraction solution was added. After gentle mixing, the solution turned blue as a result of the chemical reaction between thymol and the Gibbs reagent. The reaction mixture was allowed to stand for 15 min, after which distilled water was added to the volumetric flasks making up a 100 mL solution. The absorbance of the various solutions was measured at k5590 nm, using a UV-visible 1650PC spectrophotometer, Shimadzu. Thymol content was then calculated from a calibration curve.

### Migration Characterization

The migration characterization of the active substance was performed by using two different techniques: quantification of the EO in the film by extraction and UV-visible spectroscopy analysis (as detailed herein in section “Quantitative analysis of EO concentration in the film”) and by headspace analysis, using an auto sampler headspace GC-MS. GC-MS analysis was used to evaluate the EO concentrations as a function of time in the headspace of the package using a Thermo GC-MS system (Finnigan Trace GC ultra, Finnigan Trace DSQ) equipped with an HTA HT200H headspace auto sampler; RESTEK column, RTX-5MS Phase. Column length was 30 m, having an inner diameter of 0.25 mm and a film thickness of 0.25 μm. Each sample was held in the auto sampler conditioning oven for incubation at 40° C. for 2 min before 0.54 was injected. The GC temperature profile was set to have an initial temperature of 100° C., ramped to 200° C. at 15°/min for a total run time of 8.17 min; 50 mm² film samples were incubated in 20 mL headspace vials for 2 min at 40° C. before extraction. Quantification of EO was carried out using a calibration curve.

### Thermal Analysis

Melting temperature (Tm) and heat of fusion (ΔHm) were obtained from the differential scanning calorimetry (DSC) thermograms. DSC tests were conducted by using a TA DSC TA Q-2000 instrument (New Castle, Del.). 8 mg of films were introduced in aluminum pans (40 μl) and were submitted to the following thermal program:
(i) heating from 23 to 150° C. at 10° C. min⁻¹ (2 min hold);
(ii) cooling at 10° C. min⁻1 to 23° C. (2 min hold); and
(iii) heating to 150 at 10° C. min⁻¹.

### FTIR-Fourier Transform Infrared Spectroscopy

The interactions between the thymol and the polymers were analyzed by Fourier Transform Infrared Spectroscopy-FTIR spectroscopy (ALPHA BRUKER).

### Solubility Parameter Analysis Using Hansen Solubility Parameters in Practice (HSPiP) Software

The solubility parameters of the film components (polymers, nanoclays, and thymol) were calculated using a computer program HSPiP software (http://www.hansen-solubility.com). The HSPiP v4 program enables one to assess the level of interactivity between the materials. The program takes into account all types of interaction; dispersion forces, polar forces, and hydrogen bonds, which may be formed between any two different materials. The program was used to plot the polymers in a form of a 3D-sphere. Thymol was spatially located in the polymer sphere and the relative energy difference (RED) number was calculated. The RED number may help predict and understand the theoretical chemical affinity between the materials in the films, thereby predicting the desorption kinetics.

### Antimicrobial Activity of the Films

The antibacterial activity of the films was evaluated and compared with both untreated bacteria using E. coli ATCC 8739 as the experimental model and to a reference polyethylene control film, not comprising an antimicrobial EO. The E. coli bacteria were grown over night in Nutrient Broth (NB, Sigma) media under shaking (250 rpm) at 37° C. On the following day, the overnight culture was diluted in a fresh NB medium to OD=0.1, which approximately corresponds to 10̂8 colony forming units (CFU) per mL, and grown for 1.5 h to allow the cells to enter a logarithmic state until OD=0.6 was reached. Then, the bacteria were diluted into NB 1% (1:100) to obtain a stock solution with a working concentration of 10̂5 CFU/mL. 3 mL of the stock solution were taken into each well in a 6-well plate (DE-GROOTH). Each of the various films was laid on top of the well in a way that there was no direct contact between the film and the bacterial solution, thus the antibacterial activity, if achieved, would be due to the migration of the EO from the film to the bacterial solution. In light of the EO evaporation, there was a separation between the films, thus each plate received one film and the empty wells were filled with an equal volume of water. The plates were then incubated on a shaker (100 rpm) at 37° C. for 20-24 h. On the next day, serial dilutions were carried out and the cells were spotted onto NB agar plates. The NB plates were incubated at 37° C. for 20 h. Cell growth was monitored and determined by viable cell count.

### Film Composition

Table I lists the composition of ten sample films.

| | | | | | | EO wt % | Num- | |
|---|---|---|---|---|---|---|---|---|
| | | | | PE-g- | Poly- | in the | ber | |
| | Sample | NC | FA | MAH | mer | active | of | Outer |
| | Name | wt % | wt % | wt % | wt % | layer | layers | layer |
| 1 | VLDPE | 5 | 0 | 5 | 87 | 3 | 1 | — |
| 2 | LLDPE | 5 | 0 | 5 | 87 | 3 | 1 | — |
| 3 | MDPE | 5 | 0 | 5 | 87 | 3 | 1 | — |
| 4 | 3LEVA9 | 10 | 1.3 | 5 | 80.7 | 3 | 3 | EVA9 |
| 5 | 3LEVA18 | 10 | 1.3 | 5 | 80.7 | 3 | 3 | EVA18 |
| 6 | 3LEMA | 10 | 1.3 | 5 | 80.7 | 3 | 3 | EMA |
| 7 | 3LVLD | 10 | 1.3 | 5 | 80.7 | 3 | 3 | VLD |
| 8 | 3LLLD | 10 | 1.3 | 5 | 80.7 | 3 | 3 | LD |
| 9 | 3LMD | 10 | 1.3 | 5 | 80.7 | 3 | 3 | MD |
| 10 | Mono | 10 | 1.3 | 5 | 80.7 | 3 | 1 | — |
| | layer | | | | | | | |
| | (LLDPE) | | | | | | | |

This study is divided into two parts. In the first part, (samples 1-3) nano composites based on polymers with different levels of crystallinity were studied (the name given to each sample relates to the density of the polymer). Samples 4-10 are related to the second part of the study, wherein the influence of the outer layer in a multilayered film was determined (the name given to each sample relates to the three layers “3L” and to the specific polymer used in the outer layer of the film—“EVA9” for ethylene vinyl acetate copolymer with vinyl acetate content of 9.4 wt %, “EVA18” for ethylene vinyl acetate copolymer with vinyl acetate content of 18 wt %, VLD and VLDPE for very low density polyethylene, LD and LLDPE for low density polyethylene, MD and MDPE for medium density polyethylene, EMA for ethylene methyl acrylate etc. Sample 10 is a mono layer film, for comparison purposes. In each of the above films having three layers, both external layers were identical to one another; however, it is noted that this is not essential and that sheets could have been prepared otherwise, taking into account the change in properties caused by the different types of polymers used.

### Results and Discussion

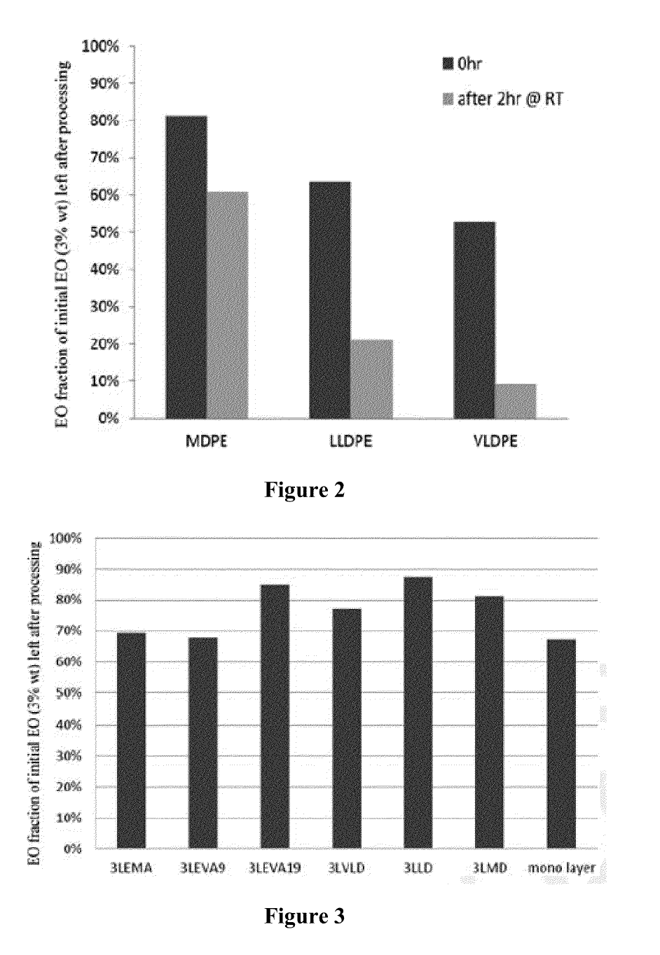

Quantitative Analysis of EO concentration in the Film Cast extrusion was performed at 230° C. This temperature may lead to a severe evaporation of the EO, which can be reduced according to the composition of the film. As presented in the results, as the polymer's density increased, less EO evaporated during processing. The nominal concentration of the EO in the film was 3% w/w, as provided and mixed with the polymeric concentrate. However, the final concentrations of the EO were dependent on the ability of the film to delay EO desorption due to tortuosity or polarity. As shown in Table II and FIG. 2, the polymer density has an influence on the ability of the film to protect the EO during processing.

TABLE II
Percentage of Initial EO (3% wt) remaining after processing
in single layer antimicrobial films having different densities

| Film sample | % of initial EO (3% wt) remaining after processing |
|---|---|
| VLDPE | 52.80 |
| LLDPE | 63.60 |
| MDPE | 81.40 |

Results of EO concentration in multilayered film compared to the concentration before processing are shown in Table III and FIG. 3.

TABLE III
Percentage of Initial EO (3% wt) remaining after processing
in three layer antimicrobial films having different external layers

| Film sample | % of initial EO (3% wt) remaining after processing |
|---|---|
| 3LEMA | 69.30 |
| 3LEVA9 | 67.80 |
| 3LEVA18 | 85.00 |
| 3LVLDPE | 77.10 |
| 3LLLDPE | 87.40 |
| 3LMDPE | 81.20 |
| Mono layer | 67.30 |

The initial concentration of the EO in the active (middle) layer of each film was 3 wt %, wherein no EO was added to the outer layers and their role was to delay desorption during processing. As shown in Table III and FIG. 3, films EVA18 and LLDPE present a relatively high ability to delay desorption during processing.

### Migration Characterization

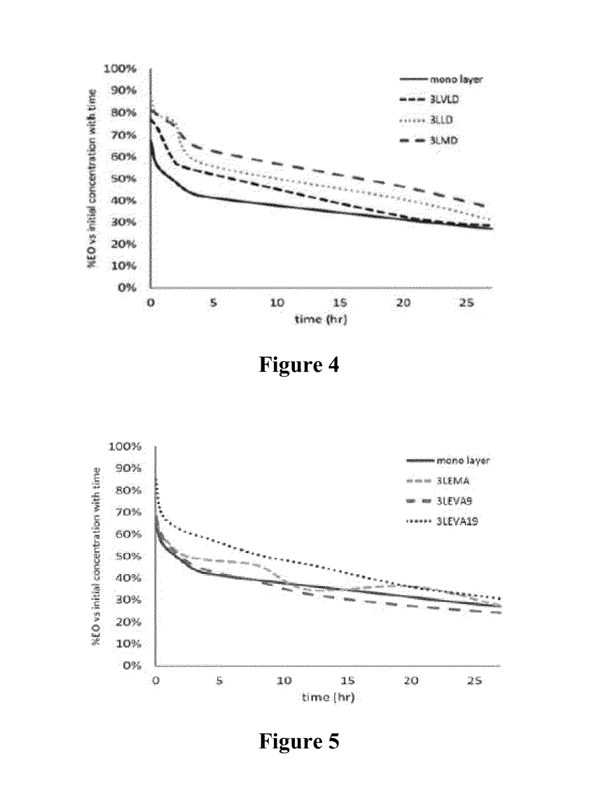

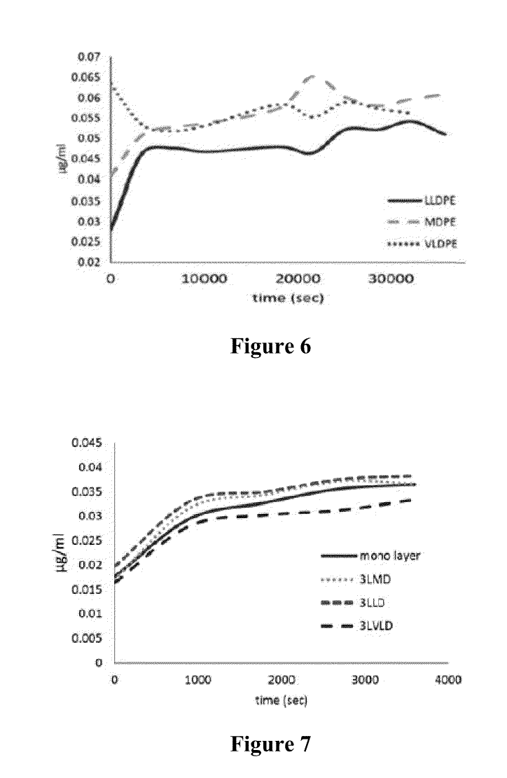

Migration depends upon the conditions in which the test is performed and on the type of media the migration occurs in (different simulants, air, etc.). Volatile antimicrobial substances, such as EOs, may protect products without direct contact, through migration of EO molecules to the headspace of the package. For this reason, it is of great importance to determine the concentration of the active compound in the headspace. In an open container, the large osmotic pressure gradient will result in fast migration. However, when stored in a closed container the migration rate will be reduced and limited by the state of equilibrium and partitioning. For this reason, two different tests were performed. First, the amount of EO in films exposed to air for different periods of times was measured (FIGS. 4 and 5) using extraction and colorimetric tests. In the second test, the amount of EO released to the headspace of a closed glass vial was evaluated by an auto sampler headspace GC-MS (FIGS. 6-8). In this test, the vials with samples were kept at room temperature, and the conditioning time of each sample was 2 minutes at 40° C.

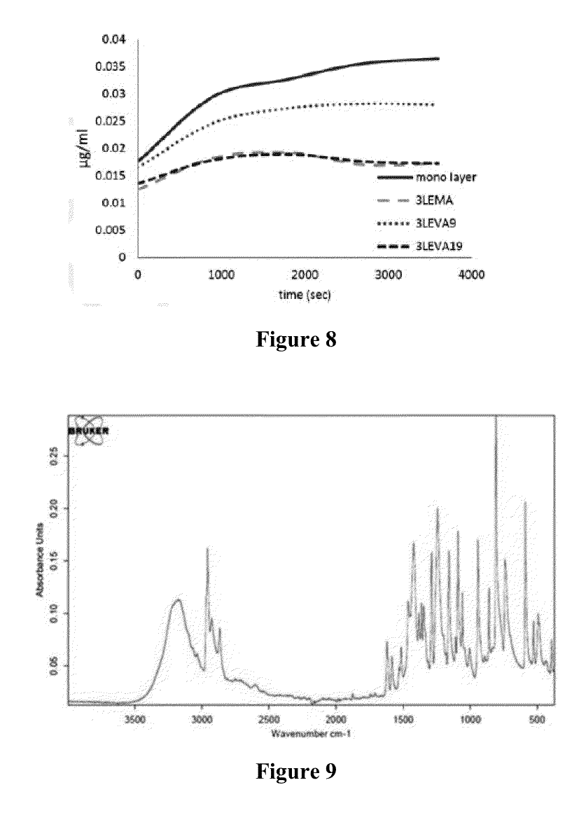

As can be seen in FIG. 6, the EO migrates very fast from the VLDPE film. However, samples with a higher density and higher crystalinity (LLDPE and MDPE) show a delay in EO desorption, leading to the conclusion that the polymer crystals create a high tortuosity, resulting in a barrier for the EO migration. FIGS. 7 and 8 depict the external layer influence on the EO desorption from multilayer films. In FIG. 6, the external layers are prepared from polymers with different densities. No significant effect on the EO desorption is noticed.

The effect of external layer (related to herein also as the “outer layer”) density on desorption to air at room temperature can be seen in FIG. 4. The crystallinity degree affects the ability of the film to hold the EO. As the crystallinity is higher, the ability to hold the EO for longer periods of time increases. In FIG. 8, the outer layers are based on polymers having different polarities. These results are correlated with the results shown in FIG. 5, wherein file EVA18 shows greater ability to control the EO release. It is noted that the shape of the obtained curve depends on various coefficients affecting the diffusion predicted by various models. According to diffusion models, diffusion coefficient affects the diffusion rate until the equilibrium, while the partition coefficient affects the equilibrium concentration in the headspace. Cran et al. studied the migration of EO from LDPE containing 0, 10, and 50% (w/w) EVA. EVA has shown two opposite effects. However, it increased the affinity between the polymer matrix and the EO causing a desorption delay, and even though it reduced the crystallinity, it accelerated the desorption. In this study, no reduction of crystallinity could be noticed, since the layer containing EO did not contain EVA. It could be noticed that the polarity has a significant influence on the EO desorption, the change in curve shape represents the ratio of the migrant concentration in the packaging to the migrant concentration in the food simulant at equilibrium, which reflects the effect in partition coefficient. An attempt to use a diffusion model based on the Crank model showed that there is a large gap between the empirical results obtained and the model.

### Polymer-EO Interactions

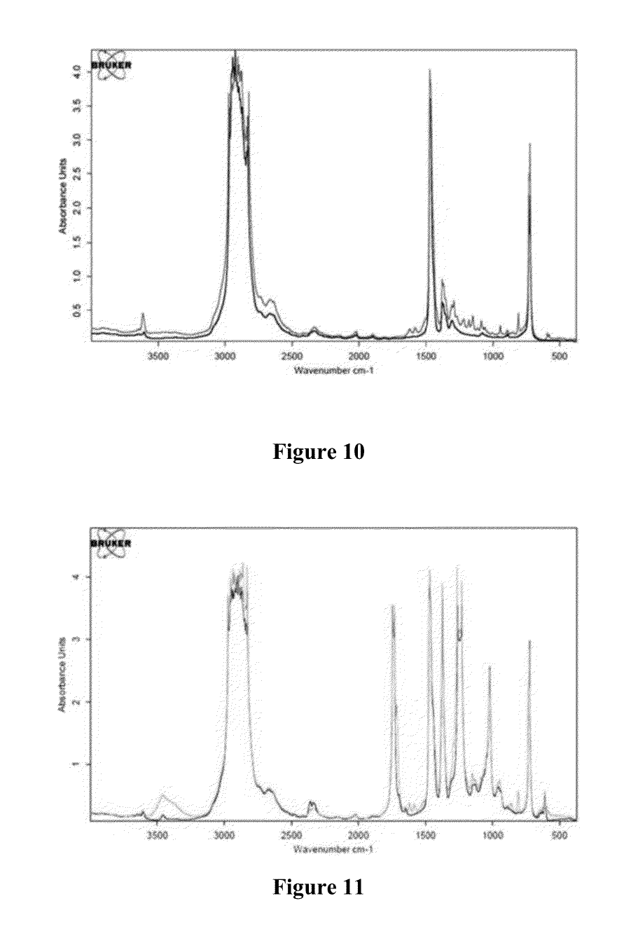

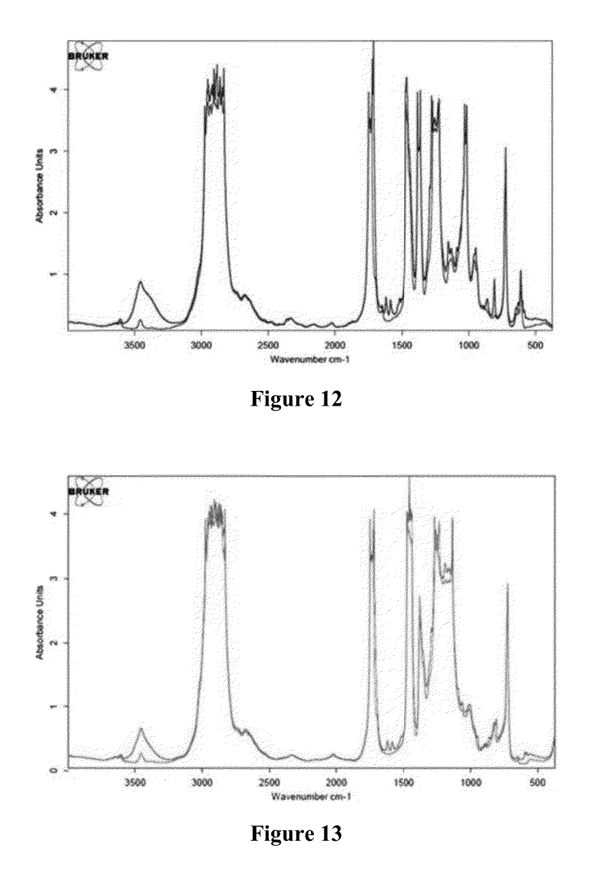

FTIR: The IR spectrum of neat thymol and compounds with thymol are presented in FIGS. 9-14. As shown therein, the most intense peaks, found at 738 and 807 cm⁻¹, are assigned to the ring vibrations of the thymol. The peaks around 3400 cm⁻¹ are assigned to hydrogen bonds, wherein free hydrogen bonds are narrower compared to peaks of bonded hydrogen bonds, and can be seen at higher wavelength (3580-3650 cm⁻¹ and 3200-3550 cm⁻¹, respectively). FIGS. 11-13 depict the increase in hydrogen bond peaks at 3450 cm⁻¹ as a result of thymol affinity to the polar polymers EVA9, EVA18, and EMA18. This peak was not found in FIG. 10 (PE spectra with and without EO).

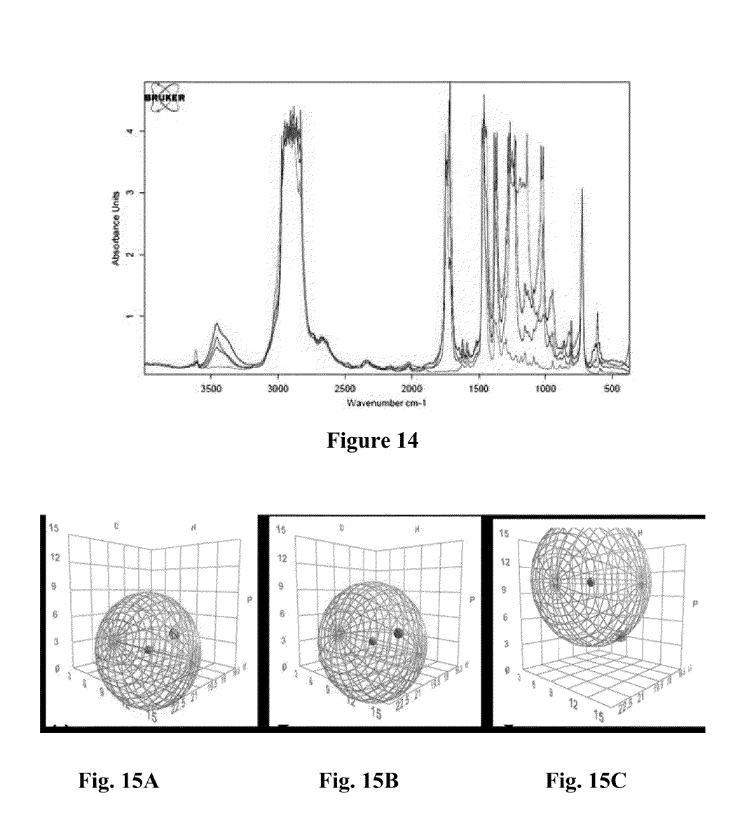

In FIG. 14, different polymers with EO spectra are shown. The hydrogen bonds peak, around 3450 cm⁻¹, represents the interaction of thymol and the polymers. When comparing the copolymers EVA9 and EVA18, the main difference between them is the polar comonomer percentage. As the polar comonomer percentage increases the interaction between the polymer and the EO becomes stronger. In addition, when comparing two copolymers with different functional groups and the same percentage of polar comonomer group, i.e., EVA18 and EMA18, the functional group influences the degree of interaction of the polymer with the EO. The interaction between EVA18 and the EO is stronger than that of EMA18. As a result; as the outer layer polymer is more polar, the desorption rate is slower due to strong interactions.

### Hansen Solubility Parameters

The HSPiP software is a convenient and simple tool that allows the prediction of interactions between different materials by using the solubility parameters and interactions of the components. The solubility parameter is a thermodynamic property derived from cohesion energy that can help to predict the ability of different components in a system to interact with one another. The solubility parameters of the tested materials are presented in Table IV.

TABLE IV
Solubility parameters of tested materials and
the RED number of thymol in different polymers (calculated by HSPiP)

| | | | | Δtotal | |
|---|---|---|---|---|---|
| Polymer | δD | δP | δH | (cal/cm³)^{0.5} | RED |
| PE | 16.90 | 0.80 | 2.80 | 8.38 | 1.22 |
| PVA | 17.60 | 2.20 | 4.00 | 8.89 | 0.96 |
| EVA9 | | | | 8.43 | |
| EVA18 | | | | 8.47 | |
| PMMA | 18.60 | 10.50 | 5.10 | 10.73 | 1.04 |
| EMA18 | | | | 8.80 | |
| Thymol | 19.00 | 4.50 | 10.80 | 10.91 | |
| Cloisite 15A | 18.20 | 3.80 | 1.70 | 9.13 | |

The solubility parameters of the copolymers EMA18, EVA18, and EVA9 were calculated using the law of mixture (X_{c}=XₘVₘ+X_{f}V_{f}), while the solubility parameters of the co-monomers are taken from the HSPiP software. PMMA was the model to examine PMA properties, since both have the same interactive groups.

The solubility parameter gap, relating to the “difference” (Δδ) of two materials, can be calculated in different ways. The equation used in the HSPiP software takes into account the contribution of dispersion, polar and hydrogen-bonding interactions:

(Difference)²=Δδ²=4(δD_{A}−δD_{B})²+(δP_{A}−δP_{B})²+(δH_{A}−δH_{B})²

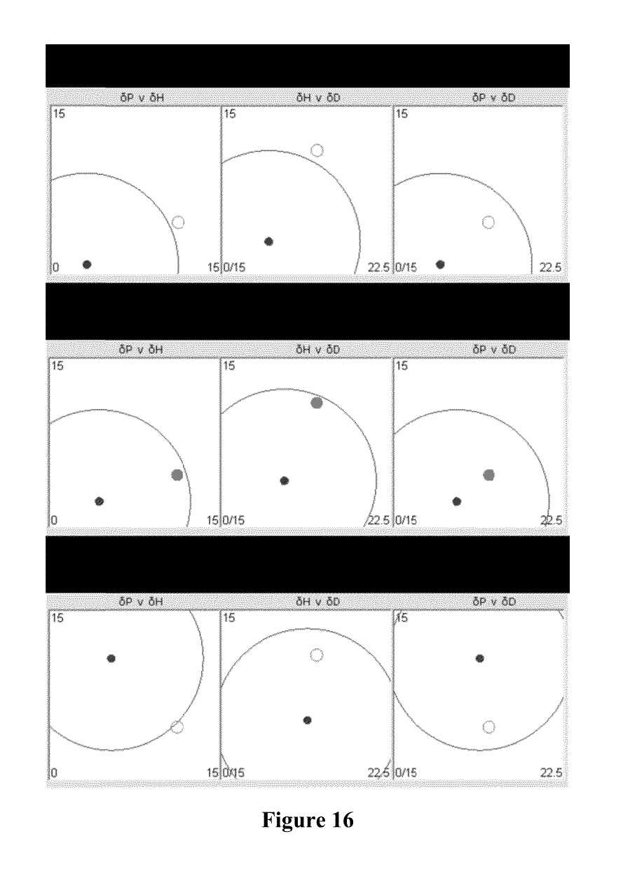

The gray dots inside the spheres in FIGS. 15 and 16 represent the solubility parameters (δD, δP, and δ/H) of a particular polymer. The light gray dots (i.e., being either solid light grey dots or small spheres/unfilled dots) in FIG. 16 represent the thymol. The RED (relative energy difference) number and the location of the light gray dot in relation to the sphere indicate the miscibility between thymol and the polymers. If the light gray dots are solid, the thymol is located inside the polymer sphere and the RED number is <1, indicating good affinity between polymer and thymol. If the light gray dots are unfilled, the thymol is outside the polymer sphere in all planes (one or two inside and one or two outside the radius), and the RED number is >1 indicating low affinity between polymer and thymol.

As can be seen in Table IV, the solubility parameter difference, DE, between the EO and the relevant polymers (PE, EVA9, EVA18, and EMA18) is quite similar [between 1.42 and 1.84 (cal/cm³)^{0.5}]. However, the type of interactions that might occur with the various polymers can differ, as can also be seen in FIGS. 15 and 16. While polyethylene leads to dispersion forces based on Van der Waals interactions only, polar polymers like PMA and PVA can lead to interactions based on polar forces and even hydrogen bonds (as shown in the FTIR FIGS. 10-14), which are able to overcome the gap in solubility parameters of the components. According to Camacho et al., the solubility parameters of EVA with different vinyl acetate content are closer to the solubility parameters of pure vinyl acetate [8.99 (cal/cm³)^{0.5} @30° C.], as the vinyl acetate content increases. That means that when comparing the solubility parameters of EVA9 and EVA18, the solubility parameter of EVA18 is closer to the solubility parameter of PVA. That can explain the lower desorption rate properties of 3LEVA18 compared to 3LEVA9.

### Thermal Properties

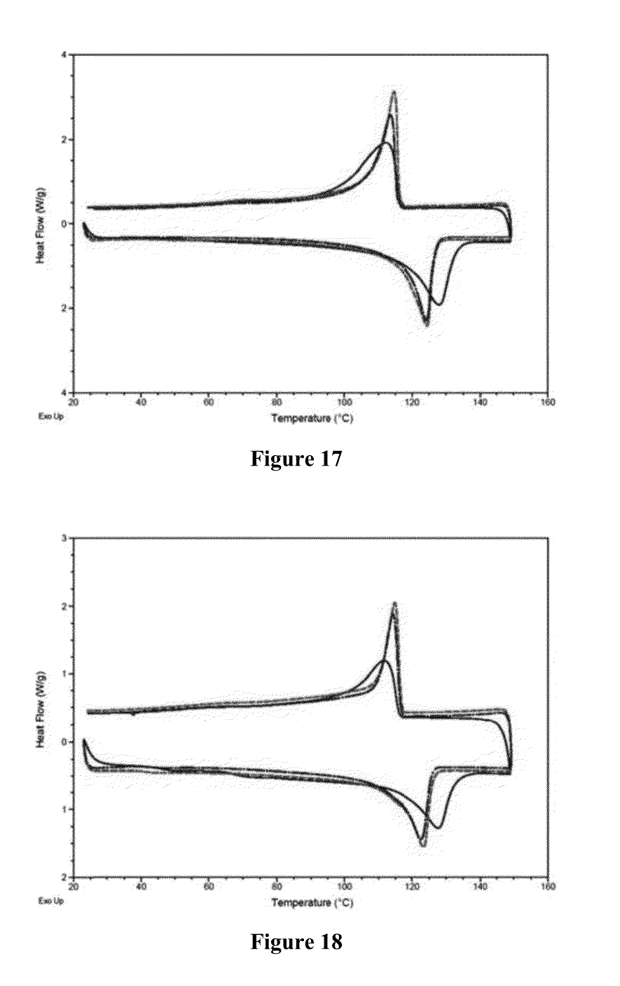

Thermal properties of polymers with different crystallinity (MDPE, LLDPE, and VLDPE samples), were studied using differential scanning calorimetry (DSC), (FIGS. 17-19). A comparison was made between the neat polymer (green), a film comprising nano-clays (NCs) and an EO (blue), and a film comprising NCs without an EO (red). As shown in FIGS. 17-19, the EO has no effect on the polymer crystallization temperature (Tc). Clay particles may provide heterogeneous surface increasing the crystals nucleation rate. The interfacial interactions between the surface treatment of the NCs and the active polymer groups can reduce molecule mobility, lowering the crystal growing rate. In other words, the NC may act as nucleator, leading to a higher uniformity in polymer crystals shape, which is presented by a sharper melting peak.

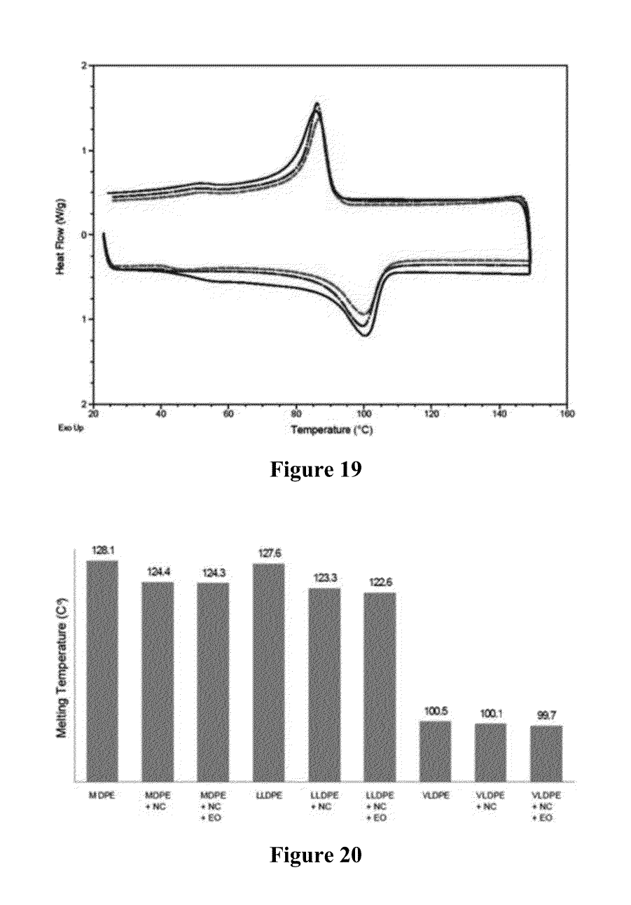

In the current study, Cloisite 15A-2M2HT: dimethyl, dehydrogenated tallow, the use of a quaternary ammonium organic modifier increased the possible interactions between the NC and the polymer molecules, affecting the crystal size and leading to a decrease in the spherulite extent. Further, the addition of NCs to MDPE and LLDPE affected the melting peak shape and crystallization peak shape from broad and small to narrow and sharp. In addition, the presence of NCs affects the melting temperature of the polymer, as presented in FIG. 20. Melting temperature of MDPE and LLDPE decreased in ˜4° C. as a result of NCs addition. In contrast, when adding NCs to VLDPE, the melting peak shape and melting temperature remained unchanged. From FIGS. 19 and 20, it can be seen that the NC does not influence VLDPE crystallinity. Zhang et al. and Persico and Ambrogi studied the addition of the nanoclay Cloisite 20A to LLDPE and Nanomer 1.28 to LDPE, respectively, and concluded that no change in the melting temperature could be noticed. However in Dadbin et al. it was noted that the addition of the nanoparticles Nanolin DK4, to a blend of LLDPE/LDPE increased the melting temperature of the polymer. Apparently, the difference in melting temperature varies according to the polymer and NC studied.

### Antimicrobial Activity of the Films

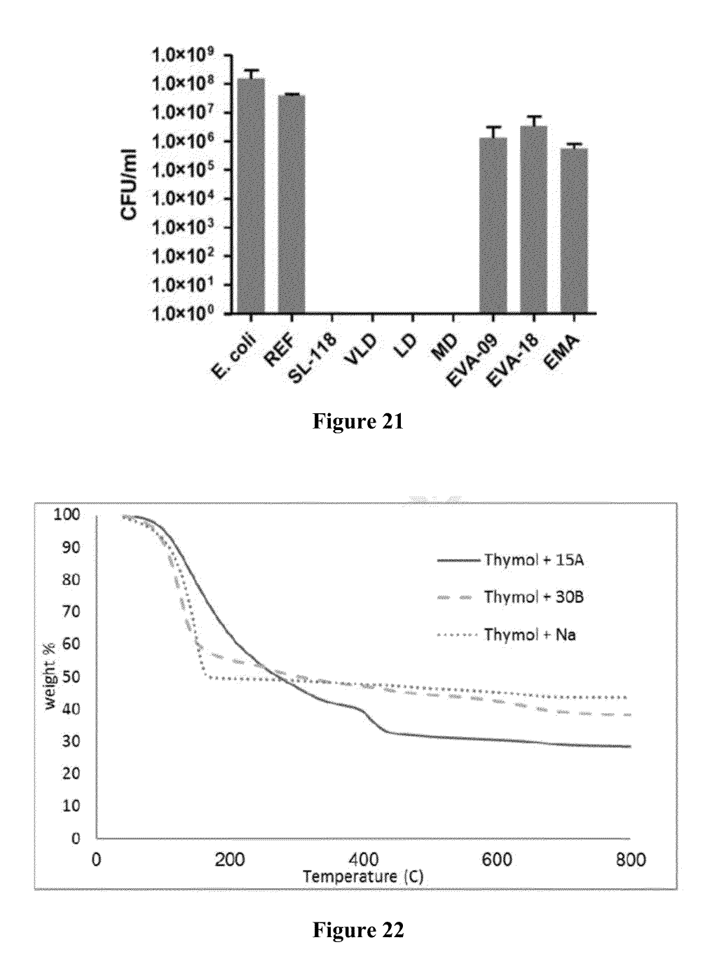

The antimicrobial properties of the various thymol containing films were tested against E. coli, a common food-born bacterial pathogen. As can be seen in FIG. 21, when nonpolar polymers (VLD, LD, and MD) are present in the outer layer of multilayered film, the ability of the film to inhibit bacterial proliferation is relatively high; however, when polar polymers (EVA09, EVA18, and EMA) are present in the outer layer of the film, this ability decreased. These results can be correlated to the FTIR results that show that thymol forms hydrogen bond interactions with the polar groups of EVA and EMA, increasing the partition coefficient and leading to a low EO concentration in the headspace. This concentration is lower than the minimal concentration needed to inhibit bacterial proliferation.

### Conclusions

The influence of the crystallinity and polarity of polyethylene copolymers on the thermal stability and controlled release of thymol in single and multilayer antimicrobial films was studied. The films were prepared using a three stage melt compounding procedure, which included the addition of a foaming agent and a NC (Cloisite 15A). The antimicrobial active agent chosen was thymol. The study on the migration behavior of thymol from the different films revealed that the PE crystallinity has a considerable effect on desorption from the film surface when the oil is stored in the bulk of a single layer film structure. As the density of the polyethylene increased (higher degree of crystallinity), a higher thymol concentration was found in the film after processing. The thermal properties have shown that the partially exfoliated nano-clays dispersed in the polyethylene matrix, affect the polymer crystallization behavior. In MDPE and LLDPE, the NC addition affects both melting and crystallization peak shapes from broad and small to narrow and sharp, while in VLDPE no effect could be seen. In multilayer films the crystallinity (density) of the polyethylene showed no significant effect on desorption, even when the higher crystalline layer is the external layer of the multilayer film. Chemical affinity between a polar PE copolymer and thymol was observed through FTIR spectroscopy (hydrogen bonds). As a result of the strong interactions, the desorption rate of the EO from the film decreased; resulting in a decrease in the antimicrobial properties of the film. Interactions between the various polar polymers and thymol differed depending on the polymer and its polar group. The antimicrobial activity of the films could be related not only to the thymol concentration in the film, but also to the capability of the film to desorb EO molecules into the headspace. This understanding can enable the prediction of the potential antimicrobial film activity, based on measured desorption properties obtained by chromatography and spectroscopy techniques.

### Example 2

### Materials

The polymer used in this study was a linear low density polyethylene (LLDPE) LL-118—BRASKEM with a Melt flow index (MFI) of 1.0 g·10 min⁻¹ (ASTM D1238 standard −190° C., 2.16 kg), and a density of 0.916 g·cm⁻³. Thymol (99.5%) was purchased from Sigma-Aldrich. PE-g-MAH Bondyram-4108 was purchased from Polyram-Israel. The foaming Agent-TRACEL PO 2201 was accepted from Tramaco. The organically modified clays Cloisite 15A, Cloisite 30B and Cloisite Na were supplied by Southern Clay Products/Rockwood Additives, and were dried in a vacuum oven at 110° C. overnight before processing. After the three above nanoclays were compared, the sheets were all prepared with Cloisite 15A.

### Sample Preparation

Different formulations were obtained using a three stage process for minimal loss of the active substance during melt processing: (i) master batch compounds (referred to herein also as concentrates) were produced by melt mixing in a EUROLAB Digital 16 (‘Prism’) twin screw co-rotating extruder (D=16 mm, L/D=24), using a uniform temperature profile of 200, 220,220,220,220 and 230° C. at the die, and operated at a screw speed of 250 rpm. The materials were physically mixed in a plastic bag, and were added to the extruder at the same upstream feed port. The melt compound strands were continuously cooled down to solidify under water at 23° C., which were then cut to granules with a granulating machine. Different concentrations of NCs and foaming agent were introduced into the polymer using a maleic anhydride based compatibilizer; (ii) the impregnation of thymol (the EO) into the foamed pellets was performed by mixing the pellets with the thymol in a closed tank at 70° C. for 24 hr. (iii) antimicrobial films were produced by dry mixing the EO containing master batches with neat LLDPE in MICROTRUDER (‘RandCastle’) Cast-film single screw extruder (D=13 mm, L/D=20), using a temperature profile of 200, 210, 220, 220, 220 and 230° C. at the die. The machine was operated at a screw speed of 70 rpm, to obtain film of 100 micron wall thickness and width of 150 mm. Samples without the active ingredient, i.e., the thymol, were also prepared and used as a control.

### Material Characterization

The active films were characterized using different techniques in order to investigate their ability to absorb and control the release of the EO. Rheological and antimicrobial properties were studied as well.

### Quantitative Analysis of EO Concentration in the Film

The amount of thymol in the samples was determined by UV-visible spectroscopy. The EO containing films were cut into small pieces and immersed in 2-propanol (1 ml 2-propanol for every 20 mg of film) for extraction. Thymol was then extracted by refluxing for 60 minutes. To 100 ml volumetric flasks containing 10 ml of a Standard Buffer Solution of Boric Acid+Potassium Chloride, 0.2 M, 1 ml of the extraction solution and 4 ml of 2-propanol were added. The solution was mixed and then, 1 ml of chloroimide solution (Gibbs reagent) was added. After gentle mixing the solution turned blue as a result of the chemical reaction between the thymol and the Gibbs reagent. The reaction mixture was allowed to stand for 15 minutes and then distilled water was added to the volumetric flasks making up a 100 ml solution. The absorbance of the various solutions was measured at X=590 nm, using a UV-visible 1650PC spectrophotometer, Shimadzu. The thymol content was calculated from a calibration curve.

### Analysis of the EO Migration

The migration characterization was performed using two different techniques: (i) quantification of the extracted antimicrobial EO from the film by UV-visible spectroscopy (as detailed in section 2.3.1) and (ii) by headspace analysis, using an auto sampler headspace GC-MS to evaluate the time dependent migration of EO to the headspace of glass vials. The headspace was analyzed by gas chromatography using a Thermo GC-MS system (Finnigan Trace GC ultra, Finnigan Trace DSQ) equipped with HTA HT200H headspace auto sampler; RESTEK column, RTX-5MS Phase. Column length was 30 m, the inner diameter was 0.25 mm and the film thickness was 0.25 μm. Each sample was held in the auto sampler conditioning oven for incubation in 40° C. for 2 min before 0.5 μl was injected. The GC temperature profile was: initial temperature was 100° C., ramped to 200° C. at 15°/min for a total run time of 8.17 min. Helium was the mobile gas phase; the carrier constant flow was 0.7 ml/min, split flow was 10 ml/min, the split ratio was 14:1. MS transfer line was at 200° C. MS: ion source temp was 250° C., mass range was 30-650, scan mode was full scan, and scan per second was 2.5. The retention time of thymol was 4.96 minutes. 50 mm² film samples were incubated in 20 ml headspace vials for 2 minutes at 40° C. before extraction. Quantitative analysis of EO was carried out using a calibration curve.

### Parallel Plate Rheometer

Viscoelastic behavior of the different composites was characterized in the melt state by a dynamic oscillatory shear rheometer (TA Instruments ARES ex2000) using parallel plate geometry with a sample diameter of 25 mm and a plate gap of 2 mm. The samples were prepared by compression molding at 200° C. The measurements were carried out at 190° C., using a constant strain of 1% and with angular frequency range of 0.1-100 rad·s⁻¹. These conditions were confirmed to be within the linear viscoelastic region of the materials. All measurements were carried out under nitrogen to minimize polymer degradation and moisture absorption.

### Wide Angle X-Ray Diffraction

The intercalation and exfoliation of clay in the polymer matrix were determined by X-ray diffraction using a Bragg-Brentano diffractometer (Phillips PW1710; Cu Ka radiation, 40 Kv 40 mA) at room temperature. A rectangular film sample with a length of 25 mm, width of 10 mm and thickness of 1 mm was made using compression molding at 200° C., and was scanned at 2Θ range from 1 to 10 at a scanning rate of 0.02°/sec.

### Scanning Electron Microscopy (SEM)

The morphologies of different samples (un-foamed/foamed master batch with different concentration of NCs; with and without thymol) were observed using ASPEX EXPLORER SEM. The samples were obtained by compression-molding at 200° C. in a hot press (Carver laboratory press, Model 2697-5, USA) and were cryogenic fractured in liquid nitrogen.

### Mechanical Properties

Tensile test of antimicrobial films were carried out on testing machine (Instron model 5543). The tests were performed using a load cell of SOON at a cross head speed of 100 mm/min and a gauge length of 50 mm. The tensile specimens were strips with width of 12.7 mm. Stress at yield (MPa), stress at break (MPa) and strain at break were obtained according to ASTM 882.

### Thermal Properties

Melting temperature (Tm), heat of fusion (ΔHm), crystallization temperature (Tc) and heat of crystallization (ΔHc) were determined from DSC thermograms of the samples with two repetitions. DSC tests were conducted using a TA DSC TA Q-2000 instrument (New Castle, Del., USA). 8 mg of films were introduced in aluminum pans (40 μL) and were submitted to the following thermal program: heating from 23° C. to 150° C. at 10° C. min⁻¹ (2 min hold), cooling at 10° C. min⁻¹ to 23° C. (2 min hold) and heating to 150° C. at 10° C. min⁻¹.

### Optical Microscope

Analysis of thymol crystals formed by a result of the blooming effect was performed using an optical microscope (Zeiss Axioplan Hamburg, Germany).

### Antibacterial Activity

The antibacterial activity of the various films was evaluated and compared using Escherichia coli ATCC 8739 as the experimental model. E. coli bacteria were grown overnight in Nutrient Broth media (NB, Sigma) under shaking (250 rpm) at 37° C. On the following day, the overnight culture was diluted in a fresh NB medium to OD=0.1, which approximately corresponds to 10̂8 colony forming units (CFU) per ml, and grown for 1.5 hours to allow the cells to enter a logarithmic state until OD=0.6 was reached. Then, the bacteria were diluted into NB 1% (1:100) to obtain a stock solution with a working concentration of 10̂5 CFU/ml. 3 ml from the stock solution were taken into each well in a 6-well plate (DE-GROOTH). Each of the various films was laid on top of the well in a way that there was no direct contact between the film and the bacterial solution, thus the antibacterial activity if achieved would be due to the migration of the oil from the film to the bacterial solution through the headspace of the well. In light of the EO's evaporation, there was a separation between the films, thus each plate received one film and the empty wells were filled with an equal volume of water. The plates were then incubated on a shaker (100 rpm) at 37° C. for 20-24 h. On the day after and in order to determine the CFU in each treatment, serial dilutions were carried out and the cells were spotted onto NB agar plates. The NB plates were incubated at 37° C. for 20 h. Cell growth was monitored and determined by viable cell count.

### Thermo Gravimetric Analysis

Thermo Gravimetric Analysis was performed using TGA Q 50—TA Instruments. The samples (3-5 mg) were heated from ambient temperature to 700° C. at a heating rate of 10° C./min and the data of weight loss vs. temperature were recorded. Each test was performed twice.

TABLE V
Film sample formulations

| | | | | | | Essential |
|---|---|---|---|---|---|---|
| | | Nano | Foaming | PE-g- | | oil |
| | Sample | clay | agent | MAH | LLDPE | (thymol) |
| | name | wt % | wt % | wt % | wt % | wt % |
| 1 | NC1FAEO | 1 | 1.3 | 5 | 89.7 | 3 |
| 2 | NC3FAEO | 3 | 1.3 | 5 | 87.7 | 3 |
| 3 | NC5FAEO | 5 | 1.3 | 5 | 85.7 | 3 |
| 4 | NC7FAEO | 7 | 1.3 | 5 | 83.7 | 3 |
| 5 | NC10FAEO | 10 | 1.3 | 5 | 80.7 | 3 |
| 6 | NC1EO | 1 | 0 | 5 | 91 | 3 |
| 7 | NC3EO | 3 | 0 | 5 | 89 | 3 |
| 8 | NC5EO | 5 | 0 | 5 | 87 | 3 |
| 9 | NC7EO | 7 | 0 | 5 | 85 | 3 |
| 10 | NC10EO | 10 | 0 | 5 | 82 | 3 |
| 11 | LL0FAEO | 0 | 1.3 | 5 | 90.7 | 3 |
| 12 | LL0EO | 0 | 0 | 5 | 92 | 3 |
| 13 | NC1FA | 1 | 1.3 | 5 | 92.7 | 0 |
| 14 | NC3FA | 3 | 1.3 | 5 | 90.7 | 0 |
| 15 | NC5FA | 5 | 1.3 | 5 | 88.7 | 0 |
| 16 | NC7FA | 7 | 1.3 | 5 | 86.7 | 0 |
| 17 | NC10FA | 10 | 1.3 | 5 | 83.7 | 0 |
| 18 | NC1 | 1 | 0 | 5 | 94 | 0 |
| 19 | NC3 | 3 | 0 | 5 | 92 | 0 |
| 20 | NC5 | 5 | 0 | 5 | 90 | 0 |
| 21 | NC7 | 7 | 0 | 5 | 88 | 0 |
| 22 | NC10 | 10 | 0 | 5 | 85 | 0 |
| 23 | LL0FA | 0 | 1.3 | 5 | 93.7 | 0 |
| 24 | LL0 | 0 | 0 | 5 | 95 | 0 |

### Results and Discussion

### Thermal Gravimetric Analysis (TGA)

The selection of the optimal NCs was performed after TGA analysis. The most significant factor is the interaction between the nano particles with the EO, which, in this study, was chosen to be thymol. Such interaction is related to the surface treatment affecting the chemical affinity between the different materials. TGA results can be used as an indication for the chemical affinity. In order to study the interactions between thymol and different surface treated NCs, samples were prepared by the mechanical mixing of thymol with NCs at a ratio of 50-50 at 70° C. in a closed container. The results shown in FIG. 22 indicate the chemical affinity between the EO and the NC. While Cloisite Na (without surface treatment) does not affect the thymol's evaporation rate, Cloisite 15A, with a non-polar surface treatment (organic modifier of dimethyl, dihydrogenated tallow, quaternary ammonium) interacts with thymol, leading to a delay in the evaporation rate. Cloisite 30B (organic modifier of methyl, tallow, bis-2-hydroxyethyl, quaternary ammonium) also affects the thymol evaporation rate but is considered less appropriate due to the high polarity of its surface treatment, enabling a poor dispersion in polyethylene matrices.

### Parallel Plate Rheometery

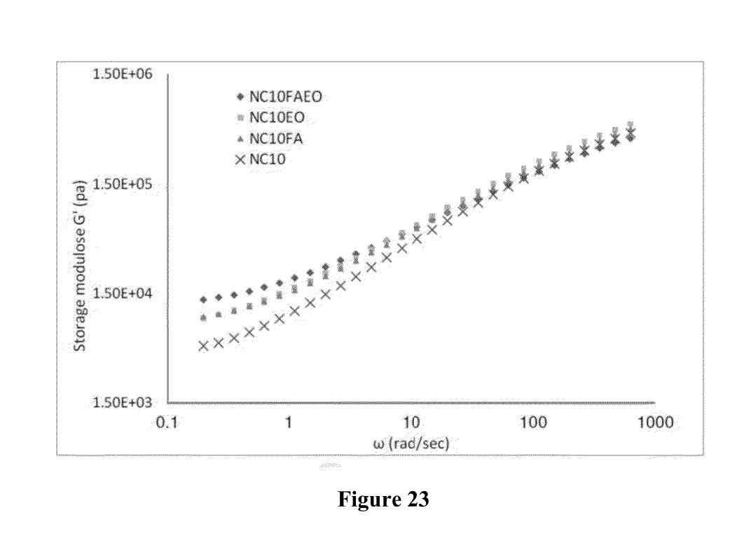

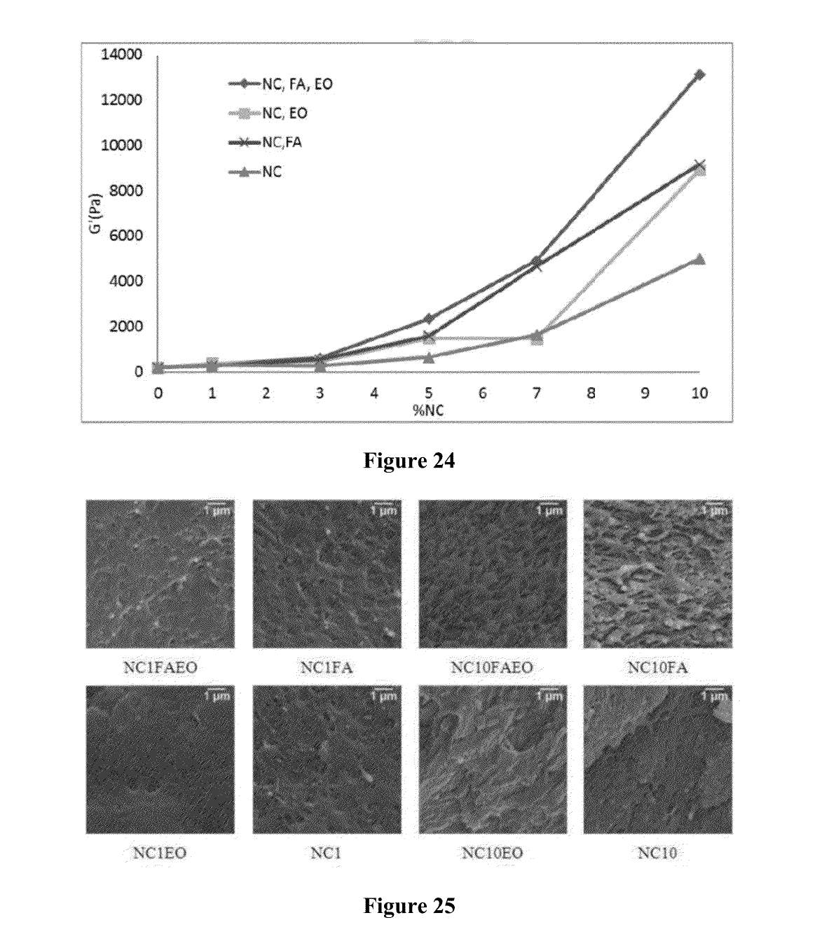

The rheology of various polymer/NC systems was analyzed using a parallel plate rheometer. Storage modulus (G′). vs. time or frequency was determined in order to estimate the degree of dispersion of NCs in the polymer matrix. Storage modulus (G′) is a rheological function sensitive to the nano particles dispersion in the polymer matrix. It is assumed that better NCs dispersions could lead to enhanced diffusion of the EO in the polymer. Different combinations of a foaming agent, NC and EO were analyzed as a function of angular frequency. FIG. 23 presents the results of storage modulus for samples with a fixed NC concentration (10 wt %). High values of G′ at lower frequencies are obtained for samples containing EO and a foaming agent, indicating a synergism between the two, leading probably, to better dispersion of NCs. FIG. 24 presents the G′ values at a fixed frequency of 0.1987 rad/sec, as a function of the NC concentration. No significant difference is noticed for low NC concentrations. For high concentrations, agglomerates seem to be formed in the polymer matrix. According to Durmus et al., high G′ values at low frequencies indicate improved NC dispersions. Therefore, it can be concluded that the addition of a foaming agent together with the EO results in a better dispersion of the NC in the polymer matrix, leading to a solid-like behavior, which is confirmed by the increase of the G′ values.

### Scanning Electronic Microscopy (SEM)

The addition of NCs leads to a visible change in the morphology of the material. The porosity degree rises and the texture becomes coarser, as shown in FIG. 25. The films produced from a master batch containing a foaming agent present micro porosity. Films without the addition of an EO have shown NC agglomerates.

### Wide Angle X-Ray Diffraction Analysis

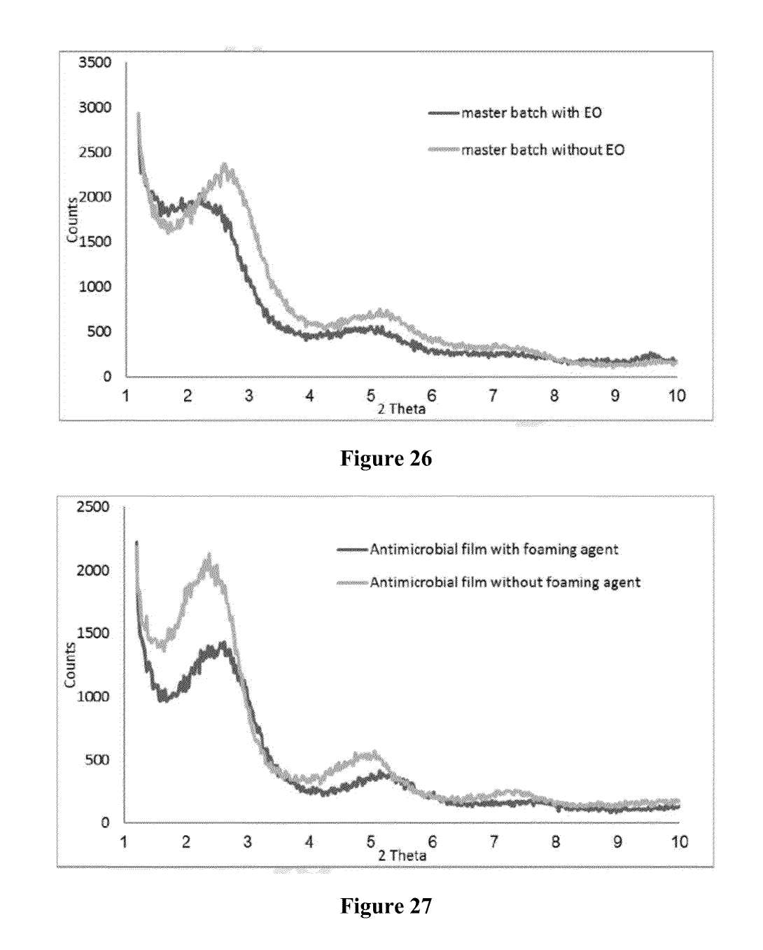

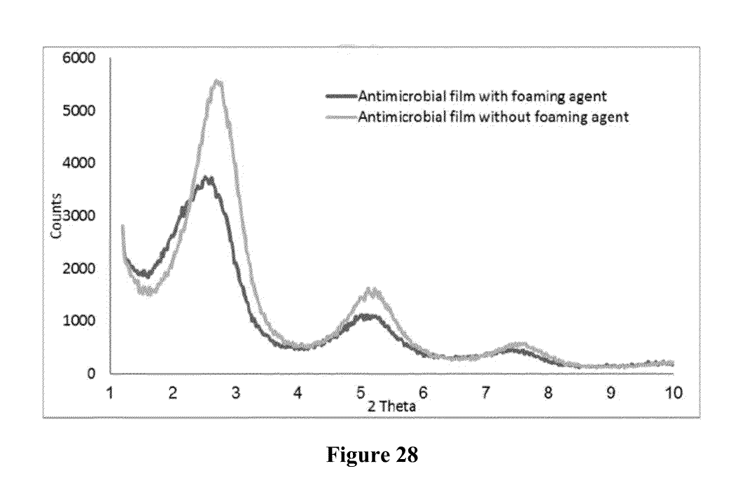

The ordered arrangement of the silicate layers of the NCs can be discerned from X-ray diffraction patterns. When polymer penetrates the clay inter-layers (intercalation) it results in an increase in interlayer spacing and a shift of XRD peaks toward lower angles. Partial or complete exfoliation of the ordered clay structure usually can be seen as a further shift to lower angles and a broadening or disappearance of the characteristic XRD peaks. As shown in FIG. 26, the addition of an EO to the master batch causes a decrease in the intensity of the peak, indicating an increase in the interlayer spacing of the NCs. According to Persico et al., the EO positively interacts with the NC, leading to a good dispersion of the EO into the clay galleries. As a result, the swelling of the NC stacks also promotes and enables a larger polymer/clay interfacial area. The higher path tortuosity obtained improves the barrier properties of the film and delays the release of the EO. According to the results exhibited in FIGS. 27 and 28 it is concluded that the addition of a foaming agent to the master batch results in a decrease of the peak intensity and a broadening of the peak, indicating a possible expansion of the clay galleries. This probably occurred as a result of shear forces generated during the foaming. A synergistic effect between the foaming agent and the EO is presented, leading to better NC dispersion in the polymer matrix, improving the intimacy between the different components in the film.

### Quantitative Analysis of EO Concentration in the Film

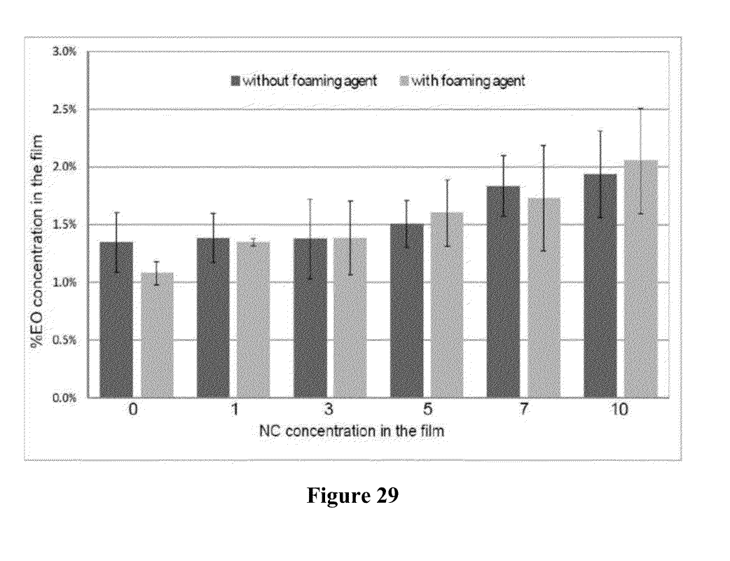

The films were obtained using extrusion cast at 230° C. However, high temperature processing is known to cause significant loss of EO. Nonetheless, the presence of additives in the film has shown to significantly affect the degree of loss. When comparing films with different clay concentrations, it was found that as the clay content increased the loss of EO during processing decreased significantly. In addition, when the clay concentration was above 5 wt %, foaming the master batch by using a foaming agent increased the amount of EO absorbed and reduced its loss during processing. The initial concentration of the EO was 3 wt %. The final concentration depended on the interactions between the EO, the NCs and the polymer. An important factor that was considered was the solubility parameter of the blend components. The information regarding the solubility parameters was obtained from HSPiP (Hansen Solubility Parameters in Practice) software v4 (http://www.hansensolubility.com). The solubility parameters of the selected hydrophobic polymer, the EO and the NCs are as follows: δ=8.16, 10.22, 9.125 (cal/cm̂3)̂0.5, respectively. When the solubility parameters of the blended components are similar, or, when the interactions between the components are strong enough to overcome the solubility parameters gap, the system will be miscible. The present system significantly delays the EO desorption from the antimicrobial film. This can lead to less antimicrobial activity since the EO may not diffuse out of the film. However, if the solubility parameters gap cannot be bridged, a noncompatible system will be obtained, and, the EO will quickly evaporate from the film. In order to obtain a controlled migration system, the solubility parameter gap should be low, leading to a compatible system. Results of the EO concentration in the film after processing are shown in Table VI and FIG. 29.

TABLE VI
Comparison between the concentration of the EO in the film before and after processing
(all materials had an initial 3% EO)

| | | Average EO | | | Average EO |
|---|---|---|---|---|---|
| | | concentration in | | | concentration |
| | STDEV (%) | the film (%) | | STDEV (%) | in the film (%) |
| LL0EO | 0.258 | 1.345 | LL0FAEO | 0.099 | 1.078 |
| NC1EO | 0.211 | 1.385 | NC1FAEO | 0.029 | 1.345 |
| NC3EO | 0.347 | 1.374 | NC3FAEO | 0.318 | 1.384 |
| NC5EO | 0.201 | 1.505 | NC5FAEO | 0.288 | 1.601 |
| NC7EO | 0.263 | 1.834 | NC7FAEO | 0.456 | 1.727 |
| NC10EO | 0.373 | 1.937 | NC10FAEO | 0.456 | 2.052 |

### Migration Phenomenon

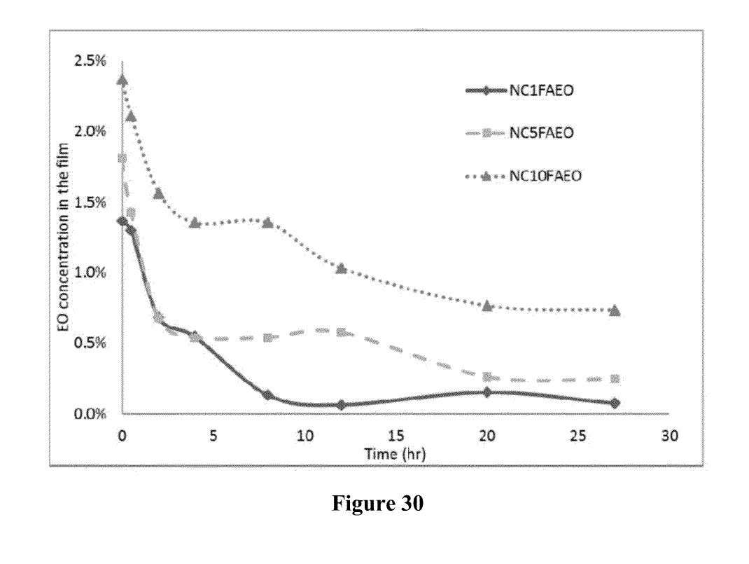

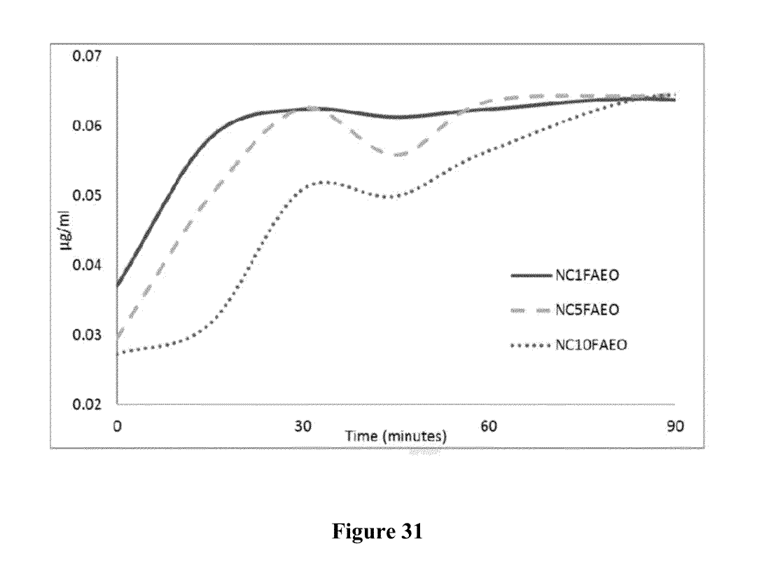

Migration depends on the conditions in which the test is being performed and on the type of media it occurs in (different simulants, air, etc.). Volatile antimicrobial substances, such as EOs, may act on foods even without direct contact between the food and the package, due to the presence of EO molecules in the headspace of the package. For this reason it is of great importance to determine the kinetics of the migration to the headspace. If a film is inserted in an open container, the large osmotic pressure gradient will result in fast migration. However, when the film is stored in a closed container the migration rate will slow down until the equilibrium. Two different migration tests were performed. In the first test the amount of EO in films exposed to air for different periods of time, was measured, using extraction and colorimetric tests (FIG. 30). In the second test the amount of EO released to the headspace of a closed glass vial was evaluated by an auto sampler headspace GC-MS (FIG. 31). In this test the vials were kept at room temperature, and the samples were conditioned for 2 minutes at 40° C. prior to injection.

A fast initial release is demonstrated in the results presented in FIG. 30. This phenomenon is typically referred to as ‘burst release’. The burst release leads to a high initial active substance delivery, reducing the controlled release effectiveness.

The presence of the NCs affects the EO migration kinetics, as shown in FIGS. 30 and 31. The migration rate is reduced as the amount of the NC in the film increases. However, although the initial rate of migration depends on the NC concentration, the equilibrium concentration reached was the same for all tested samples. According to Helmroth, the migration prediction of a specific combination of migrant, polymer and food simulant can be obtained by the model parameter values: the diffusion coefficient (D), which represents the migration rate; and the partition coefficient (K), which represents the ratio of the migrant concentration in the film to the migrant concentration in the food simulant at equilibrium. When the diffusion coefficient decreases, the time to reach the equilibrium increases. The diffusion coefficient of three different films: NC1FAEO, NC5FAEO and NC10FAEO was calculated, using the equations below:

ln(M_{inf}−Mₜ)=ln(8 M_{inf}/π²)−Dπ²t/l²

θ=−Dπ²/l²

Wherein M_{inf} is the total mass desorbed after infinite time, Mₜ is the total mass desorbed from the film at time t, D is the diffusion coefficient, and l is film thickness.

The first equation shows that for large values of t, a plot of ln(Minf−Mo) versus t provides a straight line with a slop of θ. The value of θ can be useful for the calculation of the diffusion coefficient, as shown in the second equation.

The diffusion coefficients of NC1FAEO, NC5FAEO and NC10FAEO were 8.11E-09, 5.07E-09 and 2.03E-09, respectively. The calculated diffusion coefficients in combination with the results presented in FIG. 31 show that the change in the curve shape as well as the difference in diffusion coefficients results from the NC concentration in the different films. As the NC concentration in the film increases, the diffusion coefficient and the migration rate decrease.

### Antibacterial Activity of the Films

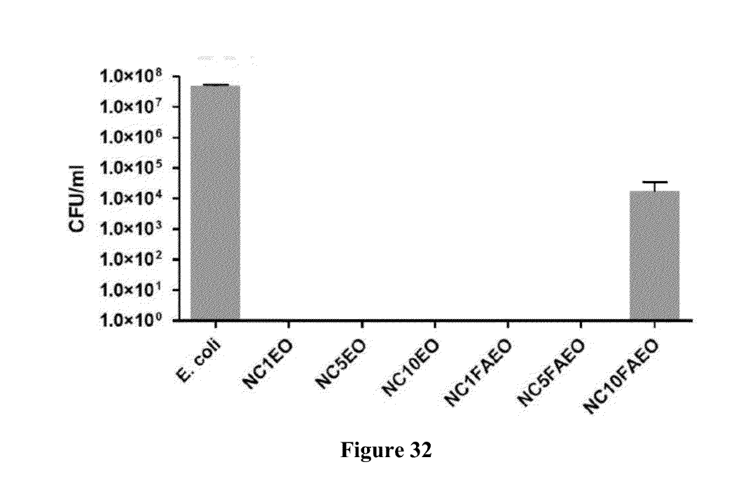

The antibacterial properties of the various films were tested against E. coli, a common food-born bacterial pathogen. As presented in FIG. 32, all of the films completely eradicated the bacteria except for NC10FAEO, which only caused partial elimination. This result can be explained by a strong interaction between the EO, the NCs and the foaming agent. The presence of the EO and a foaming agent in the NC10FAEO film aided in providing a better dispersion of the NC within the polymeric matrix; however, it also led to a better interaction between the EO and the NCs, which resulted in a lower antibacterial activity, since the EOs did not readily diffuse from the film into the product and therefore, the concentration of EO in the product was not sufficient to eliminate the bacteria completely.

Upon review of the results it appeared that there was no difference between films containing increasing concentrations of NCs and films containing both NCs and a foaming agent, wherein all such films were successful in completely eliminating the bacteria. Therefore, it was decided to challenge the system by loading 10⁵ bacteria (the initial bacteria quantity) each day until the films fail to prevent bacterial growth.

As presented in Table VII below, the NC1EO film managed to eliminate all of the bacteria only on the first day of the experiment, while films containing increased concentrations of NC (i.e. NC5EO and NC10EO) still retained their antibacterial activity. Moreover, films containing increasing concentrations of NCs with the addition of a foaming agent exerted a prolonged antibacterial activity in comparison to the ones containing NCs alone (Table VII), suggesting that the foaming agent aided in dispersing and exfoliating the NCs in the polymer matrix, increasing the interaction between the EO and the NCs. As a result, a controlled release of the EO was obtained. Nevertheless, in agreement with the results obtained and presented in FIG. 32, the NC10FAEO film was shown to be much less effective, further corroborating the assumption that the EO might be “locked” within the film.

TABLE VII
Antibacterial activity of thymol-containing films

| | Time (days) | | | | | |
|---|---|---|---|---|---|---|
| Film type | 1 | 2 | 3 | 4 | 5 | 6 |
| Untreated | 5.90E+07 | 1.45E+08 | 2.60E+08 | 1.50E+09 | 1.95E+08 | 2.00E+08 |
| E. coli | | | | | | |
| NC1EO | 0 | 3.90E+07 | 4.40E+07 | 9.00E+07 | 1.50E+08 | 1.15E+08 |
| NC5EO | 0 | 0 | 0 | 2.51E+06 | 2.50E+07 | 2.40E+07 |
| NC10EO | 0 | 0 | 0 | 2.01E+05 | 3.70E+07 | 6.50E+07 |
| NC1FAEO | 0 | 0 | 0 | 0 | 6.50E+07 | 8.00E+07 |
| NC5FAEO | 0 | 0 | 0 | 0 | 3.20E+07 | 3.10E+07 |
| NC10FAEO | 1.09E+04 | 9.50E+03 | 9.50E+05 | 8.50E+06 | 1.55E+07 | 2.05E+07 |

*The values represent CFU/ml

To further establish that the addition of a foaming agent and NCs slows down the release of the EO into the head space of the well, and that the results obtained in Table VII are indeed due to a controlled release of the EO throughout the experiment period and not due to the higher amounts of EO in the films, the NC5EO and NC5FAEO films were treated with bacteria in the same manner as presented in FIG. 32 and Table VII. The only exception was that following the first incubation, one plate for each film was replaced with a new cover plate and the film was removed (designated as ‘new’ in the table) while a second plate was left with the film (designated as ‘same’ in the table). Both NC5EO and NC5FAEO managed to cope with two bacterial loading cycles no matter whether the film was taken out after the first day of the experiment or not (Table VIII). After the third loading cycle, the ‘new’ NC5EO failed to kill the bacteria while the ‘same’ NC5EO provided only a 2log reduction compared to the control (Table VIII). This suggests that the NC5EO film did not maintain major amounts of EO within the film to provide a slow release advantage and it is likely that most of the EO was released to the medium in the first 24 h. However, for the NC5FAEO film a clear difference between the ‘new’ NC5FAEO and the ‘same’ NC5FAEO was observed on the fourth day, where the ‘new’ film almost did not affect the tested bacteria (˜1 log less than the control, i.e. untreated bacteria), while the ‘same’ film still presented excellent antibacterial activity, eradicating all of the bacteria in the medium (Table VIII). This highlights that in the presence of the foaming agent the EO was still maintained in the film and not completely released in the first loading cycles. Taken together, the results provide evidence that the EO release was delayed by the addition of a foaming agent, which enhanced the interaction between the EO and the clays, culminating in a gradual oil-releasing system.

TABLE VIII
Antibacterial activity of thymol-containing films

| | Time (days) | | | | |
|---|---|---|---|---|---|
| Film type | 1 | 2 | 3 | 4 | 5 |
| Untreated | 4.40E+07 | 1.80E+08 | 5.95E+07 | 9.00E+08 | 1E+08 |
| E. coli | | | | | |
| NC5EO new | 0 | 0 | 1.17E+08 | 6.00E+07 | 1.15E+08 |
| NC5EO | 0 | 0 | 1.07E+05 | 1.10E+07 | 3.40E+07 |
| same | | | | | |
| NC5FAEO | 0 | 0 | 0 | 5.14E+07 | 4.45E+07 |
| new | | | | | |
| NC5FAEO | 0 | 0 | 0 | 0 | 3.35E+07 |
| same | | | | | |

### Mechanical Properties

Three different antimicrobial films were tested using an Instron 4481 tensile test machine for evaluation of the influence of the EO and/or NC on the mechanical properties of the film, compared to neat polymer (LLDPE). The results are presented in Table IX. It is shown that the EO slightly decreases elongation and stress at yield.

TABLE IX
The influence of EOs and NC on the mechanical properties of
antimicrobial films

| | Stress at yield (MPa) | Strain at break (%) |
|---|---|---|
| LLDPE | 8.9 | 1020 |
| LL0EO | 8.0 | 971 |
| NC10FA | 9.3 | 764 |
| NC10FAEO | 8.4 | 906 |

### Thermal Properties

The thermal properties of three antimicrobial films were examined using differential scanning calorimetry (DSC) in order to evaluate the influence of the EO and/or NC on the thermal properties of the films, compared to neat polymer (LLDPE). The results are presented in Table X. As provided therein, the presence of the EO and/or NC caused the crystallization temperature (Tc) increased by 2-4° C. and the Tm decreased by 4-5° C., on average. The influence of the NCs on the crystallization temperature (Tc) may be caused by the effect of the NCs on the nucleation of the polymer matrix crystals. The clay can provide heterogeneous surface, increasing the crystals nucleation rate. The interfacial interactions between the surface treatment of the NCs and active groups of polymer chains can reduce molecule mobility, reducing the crystals growth rate. The addition of NCs to the polymer probably led to a crystallization mechanism characterized by a fast primary process during the initial stages and by a slower secondary process, resulting in a higher number of smaller crystals. According to Persico et al., the diffusional chain mobility promoted by the EO enhances the ability of the PE to be self nucleated, resulting in an increase of the Tc. At the same time, the plasticization effect of the EO can be observed in decreasing ΔHTm values, meaning that less energy is needed for breaking the crystalline arrangement.

TABLE X
The influence of NCs and EOs on the thermal properties of
antimicrobial films

| | Tc (C.) | Tm (C.) | ΔHTc (J/gr) | ΔHTm (J/gr) |
|---|---|---|---|---|
| LLDPE | 111.7 | 127.6 | 55.4 | 71.8 |
| LL0EO | 113.9 | 123.5 | 52.2 | 70.3 |
| NC10FA | 115.1 | 122.9 | 53.4 | 72.8 |
| NC10FAEO | 114.9 | 123.0 | 52.7 | 68.2 |

### Conclusions

Antimicrobial layered silicate nano composite films were prepared by a three stage melt compounding procedure of LLDPE in the presence of Cloisite 15A organo-modified MMT, Tracel 2201 (foaming agent) and thymol (EO). According to parallel plate and XRD results it was shown that the presence of thymol facilitates the organo-clay dispersion in the film; moreover, the incorporation of a foaming agent creates a synergistic effect leading to a better dispersion of the additives in the film. As a result of the improved dispersion of clays in the polymer matrix, as well as the improved chemical affinity between the nano composite and the EO, desorption of the EO was delayed and further, a controlled release thereof was obtained. Depending on the concentration of clays in the film, the desorption delay caused a decrease in the antimicrobial activity. It can be concluded that the antimicrobial activity of the films is related not only to the EO concentration in the film, but also to the ability of the film to desorb the EO to the headspace.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An antimicrobial sheet comprising a polymer, a nanoparticle, a foaming agent and an essential oil (EO).

2. The antimicrobial sheet according to claim 1, further comprising a compatibilizer, an additional nano-particle, an emulsifier, an additional functional additive or any combination thereof.

3. The antimicrobial sheet according to claim 1, wherein the nano-particle is a nanoclay.

4. The antimicrobial sheet according to claim 1, wherein the nano-particles are exfoliated.

5. The antimicrobial sheet according to claim 1 comprising one layer.

6. The antimicrobial sheet according to claim 1 comprising two or more layers, wherein the nano-particles and the EO molecules are in the same layer or in different layers.

7. The antimicrobial sheet according to claim 1, providing a controlled release of the EO from the sheet.

8. The antimicrobial sheet according to claim 1 for use in packaging a product that requires the control of the development of microbes therein or thereon.

9. A method for preparing the antimicrobial sheet according to claim 1 comprising
preparing a concentrate comprising a first polymer, a foaming agent and a nano-particle;
adding an antimicrobial material to the concentrate to provide an antimicrobial concentrate; and
preparing a polymeric sheet from the antimicrobial concentrate, with the addition of a second polymer.

10. The method according to claim 9, wherein the first polymer and the second polymer are the same type of polymer.

11. The method according to claim 9, wherein the concentrate further comprises a compatibilizer, an additional nano-particle, an emulsifying agent, an additional functional component, or any combination thereof.

12. The method according to claim 9, wherein the concentrate is prepared as a porous granule nano-composite.

13. The method according to claim 9, wherein the nano-particles are nano-clays.

14. An antimicrobial polymeric coating comprising a polymer, a surfactant and an EO.

15. The antimicrobial polymeric coating according to claim 14, further comprising a solvent.

16. The antimicrobial polymeric coating according to claim 14, wherein the coating is solvent-free.

17. A multilayer coating wherein at least one coating is the antimicrobial polymeric composition according to claim 14.

18. A non-woven fabric impregnated with the antimicrobial polymeric coating according to claim 14.

19. The non-woven fabric according to claim 18, wherein the non-woven fabric is coated on at least one side with an additional polymeric coating.

20. The non-woven fabric according to claim 18, further laminated, on at least one side with a thin polymeric film.

21. The antimicrobial polymeric coating according to claim 14, wherein the polymer is an adhesive resin.

22. The antimicrobial polymeric coating according to claim 21, wherein the adhesive resin is sandwiched between two polymeric films.

23. The antimicrobial polymeric coating according to claim 14, wherein the polymer is a multi-phase polymer media blend.

24. The antimicrobial polymeric coating according to claim 14, further comprising a nano-particle.

25. The antimicrobial polymeric coating according to claim 14, wherein the nano-particle is a nano-clay.
